(19) United States
(12) Patent Application Publication
(10) Pub. No.: US 2026/0253163 A1
(43) Pub. Date: Aug. 27, 2026

(54) GRAPHICS PROCESSING

(71) Applicant: Arm Limited, Cambridge (GB)

(72) Inventors: Rafal Stepuch, Cambridgeshire (GB); Philip Carlos Garcia, Austin, TX (US); Wing-Tsi Henry Wong, Lund (SE)

(73) Assignee: Arm Limited, Cambridge (GB)

(21) Appl. No.: 19/059,692

(22) Filed: Feb. 21, 2025

(51) Int. Cl. G06T 1/20

(52) U.S. Cl. CPC G06T 1/20

(57) ABSTRACT

Packets comprising primitives to be processed for a render output and bounding boxes to be used to identify primitives in the packets for respective regions of the render output are generated. Each packet comprises a set of higher level data to process a set of primitives, and sets of lower level data to process sub-sets of primitives in the set of primitives that the higher level data is for. Bounding boxes associated with the sub-sets of one or more primitives identify whether the sub-sets of primitives should be processed for a respective region of a render output. When the bounding boxes identify that a sub-set of primitives should be processed for a respective region of a render output, the set of higher level data and the set of lower level data to be used for processing the sub-set of primitives is identifiable from the packet.

The technology described herein relates to computer graphics processing, and in particular to tile-based graphics processing.

Computer graphics processing is normally carried out by first splitting a scene (e.g. a 3-D model) to be displayed into a number of similar basic components or “primitives”, which primitives are then subjected to the desired graphics processing operations. The graphics “primitives” are usually in the form of simple polygons, such as triangles, quadrilaterals, points, lines, or groups thereof.

Each primitive is usually defined by and represented as a set of vertices (e.g. three vertices in the case of triangular primitive). For a given graphics processing output, e.g. frame to be displayed, there will typically be a set of vertices defined for the output in question. The primitives to be processed for the output will then be indicated as comprising given vertices in the set of vertices for the output being generated.

Typically, the overall output, e.g. frame to be generated, will be divided into smaller units of processing, referred to as “draw calls”. Each draw call will have a respective set of vertices defined for it and respective primitives that use those vertices. For a given frame, there may, e.g., be of the order of a few thousand draw calls, and hundreds of thousands (or potentially millions) of primitives.

Each vertex for a primitive will have associated with it a set of data (such as position, colour, texture and other attributes data) representing the vertex. This vertex data is processed by a graphics processor to generate the desired graphics processing output (render target), such as a frame for display. This typically comprises “assembling” primitives using the vertices, and then processing the so-assembled primitives.

One form of graphics processing uses so-called “tile-based” rendering. In tile-based rendering, the render output (i.e. the output of the rendering process, such as an output frame to be displayed) is rendered as a plurality of smaller area regions, usually referred to as “tiles”. The render output is typically divided (by area) into regularly-sized and shaped rendering tiles (they are usually e.g., squares or rectangles). The tiles are each rendered separately (in parallel or one after the other). The rendered tiles are then combined to provide the complete render output (e.g. frame for display).

Other terms that are commonly used for “tiling” and “tile-based” rendering include “chunking” (the rendering tiles are referred to as “chunks”) and “bucket” rendering. The terms “tile” and “tiling” will be used hereinafter for convenience, but it should be understood that these terms are intended to encompass all alternative and equivalent terms and techniques wherein the render output is rendered as a plurality of smaller area regions.

When performing tile-based graphics processing, there will normally be some initial geometry processing, such as vertex processing (vertex shading) of attributes for vertices to be used for primitives for the render output being generated, to generate geometry (and other) data required for rendering the graphics processing output.

The geometry processing will then be followed by a tiling/binning process that generates appropriate data structures for determining which geometry (e.g. primitives) needs to be processed for respective rendering tiles of the output being generated.

(In tile-based graphics processing, it is usually desirable to be able to (try to) identify the geometry (e.g. primitives) for the render output that need to be processed for a given rendering tile (so as to avoid unnecessarily processing geometry that does not actually apply to a rendering tile). To facilitate this, in tile-based graphics processing, there is usually a tiling/binning process that is performed that generates appropriate data structures, such as lists of primitives that apply to a tile or tiles, for use then to identify geometry that need to be processed for a respective rendering tile.)

Once the binning/tiling process has generated the necessary data structures for identifying geometry to be processed for respective tiles of the render output, the geometry can then be, and will be, subjected to appropriate rendering/fragment processing. This may comprise, for example, rasterising primitives to be processed to fragments, fragment shading of the fragments, and/or performing ray tracing operations. This operation is performed on a tile-by-tile basis, using the data structures generated by the tiling/binning process to identify the geometry (e.g. primitives) that need to be processed for a respective rendering tile.

The rendered tiles may then be combined appropriately to provide the overall render output (e.g. frame for display).

The Applicants believe that there remains scope for improvements in how data is arranged and stored for primitives in tile-based rendering systems.

### BRIEF DESCRIPTION OF THE DRAWINGS

FIG. 1 shows an exemplary data processing system in which the technology described herein may be implemented;

FIG. 2 shows an exemplary graphics processing pipeline;

FIG. 3 shows schematically a graphics processor that may be operated in accordance with the technology described herein;

FIG. 4 shows the geometry processing pipeline of the graphics processor of FIG. 3 in more detail;

FIG. 5 shows a distributed binning core of the graphics processor of FIG. 3 in more detail;

FIG. 6 is a flowchart showing the operation of a distributed binning core of the graphics processor in an embodiment of the technology described herein;

FIG. 7 shows an exemplary packet data structure and packet bounding box array in an embodiment of the technology described herein;

FIG. 8 shows an exemplary binning data structure in an embodiment of the technology described herein;

FIG. 9 shows an operation used to identify packets and primitives therein that should be processed when processing a respective region of a render output, in an embodiment of the technology described herein;

FIG. 10 shows an exemplary hierarchy of bounding boxes for a packet in accordance with an embodiment of the technology described herein;

FIG. 11 shows a table summarising commands that can be included into a sequence of commands for a group of one or more primitives, according to an embodiment of the technology described herein;

FIG. 12 shows an encoding operation that encodes a packet by generating sequences of commands representing respective groups of primitives within the packet, in accordance with an embodiment of the technology described herein;

FIG. 13 shows a decoding operation that decodes from a packet data for primitives that should be processed when processing a respective region of a render output and outputs those primitives for processing, in accordance with an embodiment of the technology described herein;

FIG. 14 shows an exemplary sequence of commands encoding data for a group of primitives, in accordance with an embodiment of the technology described herein.

Like reference numerals are used for like features in the Figures, where appropriate.

### DETAILED DESCRIPTION

A first embodiment of the technology described herein comprises a method of operating a graphics processing system when performing tile-based rendering, in which a render output is divided into a plurality of tiles for rendering purposes, the method comprising:
generating a packet comprising primitives to be processed for a render output; and
generating bounding boxes that can be used to identify primitives in the packet to be processed for respective regions of the render output;
wherein the packet comprises:
   a set of higher level data to be used to process a set of primitives, wherein the set of primitives that the higher level data is to be used to process is identifiable from the packet, and wherein a bounding box associated with the set of primitives is usable to identify whether the set of primitives should be processed for a respective region of a render output; and
   sets of lower level data to be used to process sub-sets of one or more primitives in the set of primitives that the higher level data is for, wherein which respective set of lower level data is for which respective sub-set of one or more primitives is identifiable from the packet, and wherein bounding boxes associated with the sub-sets of one or more primitives are usable to identify whether the sub-sets of one or more primitives should be processed for a respective region of a render output;
   such that when the bounding boxes identify that a sub-set of one or more primitives should be processed for a respective region of a render output, the set of higher level data and the set of lower level data to be used for processing said sub-set of one or more primitives is identifiable from the packet.

A second embodiment of the technology described herein comprises a graphics processor operable to perform tile-based rendering, in which a render output is divided into a plurality of tiles for rendering purposes, the graphics processor comprising:
a packet generating circuit configured to generate packets comprising primitives to be processed for a render output;
a bounding box generating circuit configured to generate bounding boxes that can be used to identify primitives in a packet to be processed for respective regions of a render output; and
a packet processing circuit configured to generate and store in a packet:
   a set of higher level data to be used to process a set of primitives, wherein the set of primitives that the higher level data is to be used to process is identifiable from the packet, and wherein a bounding box associated with the set of primitives is usable to identify whether the set of primitives should be processed for a respective region of a render output; and
   sets of lower level data to be used to process sub-sets of one or more primitives in the set of primitives that the higher level data is for, wherein which respective set of lower level data is for which respective sub-set of one or more primitives is identifiable from the packet, and wherein bounding boxes associated with the sub-sets of one or more primitives are usable to identify whether the sub-sets of one or more primitives should be processed for a respective region of a render output;
   such that when the bounding boxes identify that a sub-set of one or more primitives should be processed for a respective region of a render output, the set of higher level data and the set of lower level data to be used for processing said sub-set of one or more primitives is identifiable from the packet.

The technology described herein relates to tile-based graphics processing. Thus, in embodiments, a render output (e.g. frame to be displayed) is divided into a plurality of tiles for rendering purposes and the render output is generated by separately rendering each tile the render output is divided into, and combining the rendered tiles.

(The tiles that a render output is divided into (and processed as) in this regard may comprise any suitable and desired (respective) regions (areas) of the render output that is being generated. The rendering tiles are in an embodiment all the same size and shape (i.e. regularly sized and shaped tiles are in an embodiment used), although this is not essential. The tiles are in an embodiment rectangular, and in an embodiment square. Each tile may correspond to an array of contiguous sampling positions, for example each tile being 16×16 or 32×32 or 64×64 sampling positions in size.)

In the technology described herein, bounding boxes are generated and can be used for identifying primitives to be processed for respective regions (areas) of the render output. (The regions in this regard may, and in an embodiment do, correspond to integer numbers of rendering tiles, such as single rendering tiles, and/or a set of plural rendering tiles. In an embodiment, the bounding boxes can be used to identify (and are used for identifying) whether a primitive (or set of plural primitives, as appropriate) should be processed for respective (individual) rendering tiles or not.)

In the technology described herein, packets are generated that each comprise one or more sets of primitives, and data to be used to process a set of primitives is divided into a set of higher level data and (plural) sets of lower level data, wherein respective ones of the sets of lower level data are for respective sub-sets of one or more primitives in the set of primitives. (It will be appreciated in this regard that for any given render output, a plurality of packets, each comprising one or more sets of primitives, may be, and typically will be, and in an embodiment are, generated in the manner of the technology described herein.)

The higher level data is usable in combination with different ones of the sets of lower level data to (together) be used to process different sub-sets of one or more primitives. Thus, when a primitive or primitives in a sub-set of one or more primitives are to be processed, the higher level data for the set of primitives comprising the sub-set of one or more primitives can be read (irrespective of which of the sub-sets the primitive or primitives belong to) and a set of lower level data for the particular sub-set of one or more primitives that comprises the primitive or primitives in question can also be read, and the higher level data and lower level data can both be used to process the primitive or primitives in question.

Furthermore, bounding boxes generated for processing a render output comprise bounding boxes associated with sets of primitives that higher level data is for and bounding boxes associated with sub-sets of one or more primitives that lower level data is for.

Accordingly, in the technology described herein, data stored in a packet to be used for processing primitives is hierarchical in that it comprises a set of higher level data for a set of primitives and sets of lower level data for sub-sets of one or more primitives, and bounding boxes used to identify primitives to be processed are also hierarchical, in that the bounding boxes comprise a (higher level) bounding box associated with a set of primitives that a set of higher level data is for and (lower level) bounding boxes associated with respective sub-sets of one or more primitives that a respective set of lower level data is for.

Thus, in the technology described herein, a packet comprises a hierarchical set of data to be used for processing primitives (in that the packet comprises higher level and lower level data) and the bounding boxes comprise a hierarchical set of bounding boxes wherein at least some of the levels of the hierarchy of bounding boxes are associated with levels of the hierarchical set of data (in that both the bounding boxes and sets of data comprise a level associated with a set of primitives and a level associated with sub-sets of one or more primitives within the set of primitives).

The Applicants have recognised in this regard that by generating packets comprising primitives and bounding boxes to be used to identify primitives in the packets to be processed for a respective region of the render output, the processing of primitives can be parallelised in a straightforward manner. This is because the bounding boxes can be used to determine which sets of data from those packets are required for processing primitives for a particular region (e.g., and in an embodiment, tile) of a render output, without instead relying on serialised data structures such as the use of lists of primitives that apply to a particular rendering tiles or tiles.

The Applicants have further recognised that, by dividing data to be used to process primitives into higher level data for sets of primitives and lower level data for sub-sets of primitives, and generating bounding boxes associated with sets and sub-sets of primitives that the higher and lower level data is respectively for, the bounding boxes can be used to identify the data to be used for processing primitives for a particular region (e.g. tile) of a render output in a straightforward manner while being able to avoid reading at least some of the data in packets for primitives that are not required for the region (e.g. tile) in question, and without needing to store all of the data for each primitive separately.

In the technology described herein, a set of primitives may be any suitable number of primitives.

In an embodiment, a (and in an embodiment each) packet comprises a single set of primitives that there is a set of higher level data for. Accordingly, a set of primitives in an embodiment includes all of the primitives in a packet, and a set of higher level data is in an embodiment data that is usable for processing all of the primitives in a packet.

Thus, a set of primitives that a set of higher level data in a packet is to be used to process in an embodiment comprises all of the primitives in the packet.

A set of higher level data for a set of primitives in an embodiment comprises configuration data (e.g. configuration commands) that may, for example, apply to an entire draw call of primitives, or apply to multiple draw calls of primitives.

Thus, in an embodiment, a set of higher level data for a set of primitives comprises configuration data for a draw call that primitives in the set of primitives are for.

Configuration data may be set per draw call, and may indicate, for example, a scissor box to be used when performing a scissoring operation, a depth range to be used, and/or a line width to be used.

A set of higher level data may comprise all of the configuration data that is applicable to (usable for processing) each primitive in the set of primitives that the set of higher level data is for. However, in an embodiment, at least some of the configuration data that is usable for processing primitives in a packet is stored separately to the packet, and a set of higher level data in the packet is usable to identify the configuration data stored separately to the packet that is usable to process primitives in the packet (in an embodiment, by the set of higher level data comprising a pointer to the configuration data that is stored separately to the packet).

Thus, in an embodiment, a set of higher level data in a packet comprises a pointer to (configuration) data stored separately to the packet.

The (configuration) data stored separately to the packet is, in an embodiment, usable for processing the set of primitives in the packet in question and usable for processing primitives in at least one other packet.

In an embodiment, each packet comprising a set of primitives that data stored separately to the packets is usable to process stores a pointer to said data.

In an embodiment, configuration data that is (only) applicable to relatively few packets is stored in a set of higher level data in each packet comprising primitives that the configuration data is for, and other configuration data that is applicable to relatively many packets is stored separately to the packets, and a pointer to that other configuration data is included in a set of higher level data in each packet comprising primitives that the other configuration data is for.

In an embodiment, a set of higher level data for a set of primitives is generated by identifying data (in an embodiment configuration data) usable for processing all of the primitives in the set of primitives and, for different respective portions of the data:
determining whether a portion of the data is likely to be usable to process all of the primitives in relatively few packets or in relatively many packets; and
when the portion of the data is likely to be usable to process all of the primitives in relatively few packets, including the portion of the data in the set of higher level data in the packet(s); and
when the portion of the data is likely to be usable to process all of the primitives in relatively many packets, storing the portion of data separately to the packet(s) and including a pointer to the portion of the data in the set of higher level data in the packet(s).

Whether a portion of the configuration data is likely to be usable to process all of the primitives in relatively few packets or in relatively many packets can be determined in any suitable manner. For example, this may be based on whether the number of packets that the portion of the configuration data is likely to be usable to process is determined to be above or below a threshold number of packets, may be based on whether the portion of the configuration data has particular (e.g. default) values, and/or may be based on whether the portion of the configuration data is to be used for part of a draw call, for all of a draw call, or for multiple draw calls.

In the technology described herein, a sub-set of one or more primitives may be any suitable number of primitives that is less than the total number of primitives in the set of primitives that the sub-set belongs to.

In an embodiment, one or more sub-sets of a set of primitives are each a single individual primitive.

In an embodiment, sub-sets of one or more primitives in a set of primitives comprise at least one sub-set that comprises a group of plural primitives in the set of primitives, and in an embodiment a set of primitives comprises plural sub-sets of primitives that each comprise a respective group of plural primitives.

A set of lower level data for a sub-set of one or more primitives in an embodiment identifies the primitive or primitives within the sub-set of one or more primitives, in an embodiment using vertex indices for vertices that define the primitive or respective ones of the primitives in the sub-set of one or more primitives.

A packet in an embodiment also comprises attributes for vertices that define primitives included in the packet, and vertex indices can in an embodiment be used to identify which vertices define a primitive and what vertex attributes apply to the vertices that define a primitive.

A set of lower level data for a sub-set of one or more primitives in an embodiment (also) identifies processing operations or parameters that should be used when processing (rendering) the primitive or respective ones of primitives within the sub-set of one or more primitives.

Accordingly, a set of lower level data for a sub-set of one or more primitives in an embodiment includes state data indicating processing operations or parameters to use when processing primitive(s). For example, state data may include a variable rate shading (VRS) rate to use when rendering a primitive or primitives, and/or a scissor index to use to determine how a scissor operation is to be performed for a primitive.

Thus, in an embodiment, a set of lower level data for a sub-set of one or more primitives identifies:
the primitive or primitives within the sub-set of one or more primitives; and
processing operations or parameters that should be used when processing the primitive or respective ones of primitives within the sub-set of one or more primitives.

A (and in an embodiment each) sub-set of one or more primitives in a set of primitives is in an embodiment able to be processed using the set of higher level data for the set of primitives and the respective set of lower level data for the sub-set of one or more primitives in question, but independently of (i.e. without using) other sets of lower level data for other sub-sets of one or more primitives in the set of primitives. Thus, the sets of lower level data are in an embodiment defined (encoded) independently of (without referencing) one another.

Thus, in an embodiment, a sub-set of one or more primitives in a set of primitives is able to be processed using the set of lower level data for the sub-set and independently of (and without needing) any other set of lower level data for any other sub-set of one or more primitives in the set of primitives.

In this regard, the Applicants have recognised that although providing sets of lower level data that are independent of one another may require a larger data size compared to if the sets of lower level data are not independent of one another (as having the sets of lower level data be independent of one another may require some duplication of data between different sets of lower level data), this can reduce the overall amount of data that needs to be read to process a particular sub-set of primitives, and can allow sub-sets of primitives to be processed in any particular order for processing the different sub-sets, and/or allow different sub-sets to be processed in parallel.

In an embodiment, data within a set of lower level data is encoded relative to other data in the set of lower level data. The Applicants have recognised that by encoding data within a set of lower level data relative to data in the same set of lower level data, a data size of a set of lower level data can be reduced (e.g. while allowing different sets of lower level data to be read in parallel).

In an embodiment, a set of lower level data for a sub-set comprising a group of plural primitives in the set of primitives encodes data for one or more primitives in the group of plural primitives relative to data for at least one other primitive in the group of plural primitives.

A set of lower level data in an embodiment comprises a set of commands to be used to process a sub-set of one or more primitives, and in an embodiment the set of commands is a sequence of commands, wherein the positions of commands in the sequence controls the order in which the commands are to be read.

In an embodiment, a (and in an embodiment each) set of lower level data for a sub-set of one or more primitives comprises a sequence of commands that comprises commands for identifying respective primitive(s) in the sub-set of one or more primitives and commands for identifying processing operations or parameters that should be used when processing respective primitive(s) in the sub-set of one or more primitives.

In an embodiment, when a sub-set of primitives comprises a group of plural primitives, commands for identifying respective primitives in the sub-set of primitives comprise one or more commands that each identify an individual primitive.

In an embodiment, a set of lower level data for a sub-set of primitives comprising a group of plural primitives comprises a set of commands to be used to process the group of plural primitives, the set of commands comprising:
one or more commands that each identify a processing operation or parameter that should be used when processing an individual primitive in the group; and
one or more commands that each identify a processing operation or parameter that should be used when processing plural ones of the primitives in the group.

In an embodiment, a sequence of commands for a set of lower level data comprises a type of command that is usable to identify a processing operation or parameter that should be used when processing an individual primitive or plural primitives, and the sequence of commands defines whether a command of said type of command identifies a processing operation or parameter that should be used when processing an individual primitive or identifies a processing operation or parameter that should be used when processing plural primitives.

In an embodiment, a set (e.g. sequence) of commands for a set of lower level data comprises one or more commands that are defined (e.g. encoded) relative to one or more other commands in the set (e.g. sequence) of commands.

Commands defined relative to one or more other commands in an embodiment include commands identifying respective primitives and/or commands identifying processing operations or parameters that should be used when processing respective primitives.

In an embodiment, sequences of commands for sets of lower level data are defined (encoded) independently of one another (so that a sequence of commands is not defined relative to another sequence of commands). By defining the sequences of commands independently of one another, different ones of the sequences of commands are in an embodiment able to be processed in any particular order and/or in parallel relative to other ones of the sequences of commands.

In the technology described herein, bounding boxes are usable to identify which primitives should be processed for a respective region (e.g. tile) of a render output. In particular, the bounding boxes are usable to determine which (if any) set of primitives in a packet should be processed for a respective region (e.g. tile) of a render output, and which (if any) sub-set of primitives in the set of primitives should be processed for a respective region (e.g. tile) of a render output.

The bounding boxes are in an embodiment usable to identify which primitives should be processed for a respective region of a render output by determining which bounding boxes intersect with the region in question. In an embodiment, it is determined that primitives associated with (e.g. bounded by) a bounding box should be processed for a region of a render output when the bounding box intersects with the region (e.g. tile) in question.

The bounding boxes in an embodiment comprise packet bounding boxes associated with respective ones of the packets, and a packet bounding box is in an embodiment usable to identify whether a packet associated with it should be processed for a region of a render output.

In an embodiment, a set of primitives includes all of the primitives in a packet, and a bounding box associated with (e.g. bounding) the set of primitives is used as the packet bounding box associated with the packet.

Packet bounding boxes are in an embodiment stored separately to the packets, in an embodiment as a data structure (a binning data structure) that comprises packet bounding boxes and is usable to identify which packet is associated with which packet bounding box, in an embodiment by the data structure storing pointers to packets and being usable to identify which pointer points to a packet associated with which of the packet bounding boxes.

A packet in an embodiment stores (e.g. encodes) bounding boxes associated with respective sub-sets of one or more primitives in the packet.

Bounding boxes associated with sub-sets of plural primitives in an embodiment comprise group bounding boxes that are each associated with (e.g. bound) a respective group of plural primitives.

When a sub-set of one or more primitives is a single individual primitive, a bounding box associated with the sub-set of one or more primitives is in an embodiment a primitive bounding box that is associated with (e.g. bounds) the individual primitive in the sub-set.

When bounding boxes associated with groups of plural primitives are generated, primitive bounding boxes associated with respective individual primitives are in an embodiment (also) generated.

Thus, in an embodiment, the bounding boxes comprise packet bounding boxes associated with respective packets, group bounding boxes associated with respective groups of primitives (sub-sets of primitives) in a packet, and primitive bounding boxes associated with respective individual primitives in a group (sub-set) of primitives.

A primitive bounding box associated with a primitive is in an embodiment usable to determine whether the primitive should be processed for respective region (e.g. tile) of a render output.

In an embodiment, a packet stores (e.g. encodes) primitive bounding boxes associated with respective individual primitives in the packet.

Thus, in an embodiment, bounding boxes associated with individual primitives in a group of plural primitives are stored in a packet comprising the group of plural primitives, the bounding boxes associated with individual primitives in the group of plural primitives being usable to identify whether respective ones of the primitives in the group of plural primitives should be processed for a respective region of a render output.

In an embodiment, bounding boxes associated with individual primitives in a group of plural primitives are stored (e.g. encoded) in a set of lower level data for the sub-set that comprises the group of plural primitives.

In an embodiment the bounding box positions are defined and expressed in terms of the tile positions within the render output, such that each bounding box bounds a whole number of tiles. Other arrangements, would of course be possible.

In an embodiment, primitive bounding boxes associated with individual primitives in a sub-set of primitives are encoded relative to one another and/or relative to a (group) bounding box associated with the sub-set of primitives.

In an embodiment, a set of lower level data to be used to process a sub-set of primitives comprises a set of commands including commands that encode primitive bounding boxes associated with individual primitives in the sub-set of primitives.

Accordingly, a set of commands to be used to process a sub-set (group) of plural primitives in an embodiment comprises commands encoding bounding boxes associated with individual primitives in the sub-set (group) of plural primitives.

In an embodiment, a bounding box associated with an individual primitive in a sub-set comprising a group of plural primitives is encoded relative to a bounding box associated with another individual primitive in the group of plural primitives.

In another particularly embodiment, a bounding box associated with an individual primitive in a sub-set (group) of primitives is encoded relative to a bounding box associated with the sub-set (group) of primitives or a bounding box associated with the set of primitives that comprises the sub-set.

In an embodiment, (group) bounding boxes associated with respective sub-sets of primitives are stored separately to the lower level data in a packet.

In an embodiment, a packet comprises a header storing (group) bounding boxes associated with respective sub-sets of primitives in the packet. The header in an embodiment (also) stores a set of higher level data to be used to process the set of primitives that comprises the sub-sets of primitives.

In an embodiment, (group) bounding boxes associated with respective sub-sets of primitives are encoded relative to one another and/or relative to a (packet) bounding box associated with a set of primitives that comprises the sub-sets of primitives.

In an embodiment, (group) bounding boxes associated with respective sub-sets of primitives are encoded relative to a (packet) bounding box associated with a set of primitives that comprises the sub-sets of primitives, and primitive bounding boxes associated with individual primitives in a respective sub-set of primitives are encoded relative to one another.

In the technology described herein, the packets may be generated in any suitable and desired manner. In an embodiment, a packet comprising higher level and lower level sets of data is generated using a packet storing data for primitives in a different format, and in an embodiment by encoding data from a packet storing data for primitives in a different format.

In an embodiment, geometry packets are initially generated, for example by progressively adding attributes and/or work items (e.g. vertices) relating to one or more primitives, e.g. until a condition for finishing the packet (and, if necessary, starting a new packet) is reached, such as a maximum amount of vertices or primitives for the packet being met.

In an embodiment, geometry packets are processed by a sequence of one or more (geometry) processing stages.

A first stage of the processing stages generates the initial geometry packets. The first stage in an embodiment also performs at least some vertex shading (in an embodiment including position shading).

The initial packets are then in an embodiment appropriately processed by (any) subsequent stages of the sequence of processing stages to generate, for example, modified versions of the initial geometry packets and/or to generate additional geometry packets, as required. Subsequent stages may include, for example, mesh shading, tessellation evaluation shading, geometry shading, and/or transform feedback shading.

In an embodiment, primitive packets are generated and processed by a sequence of packet processing pipeline stages.

The packet generating process/circuit (stage) in an embodiment generates (primitive) packets comprising primitives to be processed for a render output using geometry packets that have been processed by the geometry processing stages.

The bounding box generating process/circuit (stage) can in an embodiment generate primitive bounding boxes for primitives in a respective primitive packet, and the primitive bounding boxes are in an embodiment stored in the appropriate packets for primitives that are associated with the bounding box in question. The bounding box generating process/circuit can in an embodiment also generate a packet bounding box using the primitive bounding boxes generated for a packet. As described above, a packet bounding box is in an embodiment stored in a data structure separate to the packets.

The packet processing circuit (pipeline) in an embodiment comprises an encoding process/circuit (stage), in an embodiment as the final stage in the packet processing pipeline, and the encoding process/circuit (stage) in an embodiment generates sets of higher level data and lower level data by encoding packets processed by the previous stages in the packet processing pipeline (to provide encoded packets).

Thus, in an embodiment, generating a packet comprising primitives to be processed for a render output comprises generating one or more initial (geometry) packets, and adding attributes and/or work items (e.g. vertices) relating to one or more primitives to the initial packet(s). An initial packet is in an embodiment processed to generate a primitive packet (by a packet generating circuit), and the primitive packet processed and encoded (by a packet processing circuit) to generate a packet comprising a set of higher level data and sets of lower level data.

A bounding box associated with a set of primitives is in an embodiment generated when processing a (primitive) packet at the bounding box generating stage. Primitive bounding boxes associated with individual primitives are in an embodiment (also) generated when processing a (primitive) packet at the bounding box generating stage. However, any particular order in which the bounding boxes are generated is not essential.

Bounding boxes associated with sub-sets of one or more primitives are in an embodiment generated when encoding a (primitive) packet, and are in an embodiment generated using primitive bounding box(es) associated with primitive(s) in the sub-set in question.

Bounding boxes associated with sub-sets of one or more primitives are in an embodiment encoded, for example relative to a bounding box associated with the set of primitives (e.g. relative to a packet bounding box) or relative to one or more other bounding boxes associated with a (different) sub-set of one or more primitives (in an embodiment of the same set of primitives).

In an embodiment, the graphics processor is operable for some of the geometry processing and/or primitive packet processing to be deferred for at least some of the packets until a later stage in the processing. For example, at least some of the processing for one or more packets may be deferred until it is identified that the one or more packets should be processed for a region of a render output.

When processing is deferred, in an embodiment (at least) position shading for primitives is performed before deferring subsequent processing, to allow bounding boxes to be generated based on the positions of the primitives.

When the processing of a packet is deferred, any (parent) geometry packets required for completing the processing of the packet whose processing is being deferred are, in an embodiment, stored so that they can be retrieved when the processing of the packet is to be completed.

In an embodiment, a packet bounding box is generated for a deferred packet (a packet for which at least part of the processing is being deferred), the packet bounding box being usable to identify whether the packet should be processed for a respective region of a render output being processed.

When it is identified that a deferred packet should be processed, any (parent) geometry packets required for completing the processing of the deferred packet are in an embodiment read, and the processing of the deferred packet now completed in the same manner as discussed above, to thereby generate an (encoded) packet comprising a set of higher level data and sets of lower level data.

The above primarily describes the process of generating packets comprising hierarchical data in the manner of the technology described herein.

Once an appropriate set of such packets comprising primitives has been generated for a render output, the packets can then be used and processed to render the render output in question.

The operation of the graphics processor and graphics processing pipeline when using packets generated in the manner of the technology described herein and processing primitives therein to render a render output will now be described.

As discussed above, the technology described herein relates to tile-based rendering, and thus a render output being generated will be rendered on a tile-by-tile basis. Accordingly, when using a set of packets comprising primitives that have been generated for a render output in the manner of the technology described herein to render a render output, it is in an embodiment determined, for a (and each) respective region of the render output that the render output has been divided into for this purpose, which packets should be processed for the region in question.

(The regions of the render output in this regard may, and in embodiments do, correspond to respective individual rendering tiles that will be rendered for the render output, but they could also or instead, if desired, comprise other subdivisions of the render output, for example corresponding to respective sets of plural rendering tiles (so as to identify whether a given packet (potentially) applies to the set of rendering tiles that the render output region corresponds to, for example).)

As discussed above, whether a packet should be processed for a respective region of a render output is in an embodiment determined using a bounding box associated with the packet (in an embodiment stored in a binning data structure) (and in particular based on whether the bounding box intersects with the region in question or not). Accordingly, in an embodiment, bounding boxes associated with packets are used to identify whether any of (and which of) the packets should be processed for a respective region of a render output.

When it is determined that a packet should be processed for a region, a set of higher level data for processing a set of primitives in the packet is in an embodiment then read.

In this regard, in the case where, as discussed above, a packet comprises a (single) set of higher level data for all the primitives in the packet (a single set of primitives), then the higher level data that applies to all the primitives in the packet can simply be, and is in an embodiment, read from the packet. In this case, there may be, and is in an embodiment, a single bounding box associated with the packet that is correspondingly associated with the (single) set of primitives that the packet comprises.

On the other hand, in the case where a packet comprises plural sets of primitives, then in an embodiment respective bounding boxes associated with the different sets of primitives are used to determine whether a (and each) set of primitives that the packet relates to should be processed for the region, and, correspondingly, the respective set or sets of higher level data that should be read from the packet for processing a respective set of primitives in the packet.

When it is identified that a set of primitives of a packet should (potentially) be processed for a region of a render output, as well as reading a set of higher level data for processing the set of primitives, any bounding boxes associated with sub-sets of one or more primitives in the set of primitives are in an embodiment then read and used to identify whether any of the sub-sets of one or more primitives should be processed for the region of the render output.

Thus, when it is identified that a set of primitives in a packet should be processed for a region of a render output, a set of higher level data for processing the set of primitives in the packet is in an embodiment read from the identified packet, and bounding boxes associated with sub-sets of one or more primitives in the set of primitives are in an embodiment used to identify whether any of the sub-sets of one or more primitives for the set of primitives should be processed for the region of the render output.

For a (and each) sub-set of one or more primitives that it is identified should be processed for a region of a render output, a set of lower level data for processing the primitive or primitives in the sub-set of one or more primitives is in an embodiment read (from the packet).

Thus, in addition to reading a set of higher level data, it is in an embodiment identified which (if any) sets of lower level data in the packet should be read, in an embodiment using bounding boxes associated sub-sets of one or more primitives in a set of primitives of the packet (rather than simply reading all of the lower level data in the packet). Primitive(s) in a sub-set that it is identified should be processed can then be processed using the appropriate higher level and lower level data.

Once a set of higher level data for a set of primitives has been read from a packet, and a set of lower level data for a sub-set of primitives in the set of primitives has been read from the packet, a primitive or primitives in the sub-set of one or more primitives can be, and is in an embodiment, then processed using the set of higher level data and the set of lower level data.

In the case where a given sub-set of primitives corresponds to a single primitive only, then the primitive in question can accordingly be, and is in an embodiment, processed using the set of higher level data for the set of primitives that the primitive belongs to and the set of lower level data for the primitive in question, that is indicated by the packet.

On the other hand, in the case when it is identified that a sub-set of primitives comprising a group of plural primitives should be processed for a respective region of a render output, it is in an embodiment then identified which primitive or primitives in the group (in the sub-set) of plural primitives should be processed (and which primitives (if any) in the group (sub-set) need not be processed) for the region.

(When it is identified that a primitive need not be processed for a respective region of a render output, the primitive is in an embodiment culled from further processing for the region in question.)

Again, which primitives in a sub-set of primitives should be processed for a respective region of a render output is in an embodiment determined using bounding boxes, and in an embodiment using bounding boxes associated with (for) (e.g. bounding) (the) individual primitives.

As discussed above, any bounding boxes to be used to determine which primitives in a sub-set of primitives should be processed for a region are in an embodiment stored in the packet comprising the sub-set of primitives, and in an embodiment in the packet in (as) a set of lower level data for the sub-set of primitives.

Thus, in an embodiment, for a (and in an embodiment for each) sub-set of primitives comprising a group of plural primitives that it is identified should be processed for a region of a render output, a set of lower level data for processing the group of plural primitives is read from the packet in question, it is identified whether any of (and which if any of) the primitives in the group of plural primitives should be processed for the region of the render output (in an embodiment using the set of lower level data), and when it is identified that one or more primitives in the group of plural primitives should be processed for the region of the render output, the one or more primitives are processed using the set of lower level data for the sub-set of primitives and a set of higher level data for the set of primitives comprising the sub-set of primitives.

When it is identified that some but not all of the primitives in a sub-set of primitives should be processed for a region of a render output, it is in an embodiment identified which data in the set of lower level data is for the primitive or primitives that should be processed for the region of the render output, and that data is then used to process the primitive or primitives.

In order to facilitate the above operation, the graphics processor in an embodiment correspondingly comprises appropriate processing circuits for that purpose.

Thus, in an embodiment, the graphics processor comprises a packet reading circuit configured to read data for processing primitives from packets and to provide primitives for a respective region of a render output, and data for processing those primitives (based on the appropriate set(s) of higher level data and set(s) of lower level data), to an appropriate (primitive) processing circuit of the graphics processor.

Correspondingly, to provide a (primitive) processing circuit with primitives and associated data for processing for a region of a render output, the packet reading circuit is in an embodiment configured to, and operable to, identify which packets should be read for a region, and then identify which primitives in a packet should be processed for a region and which sets of data should be used for processing those primitives (in the manner discussed above).

The graphics processor is in an embodiment operable to, and configured to be able to, process different regions of a render output in parallel with one another.

The graphics processor may accordingly, and in embodiments does, comprise plural packet reading circuits and/or (primitive) processing circuits, to facilitate this (if required).

As discussed above, in embodiments of the technology described herein, (at least) the sets of lower level data may be, and in an embodiment are, stored in a packet in an encoded format. Accordingly, the reading of the relevant lower level data (and any other encoded data) from a packet in an embodiment comprises correspondingly decoding the (e.g. lower level) data accordingly.

In this case, the graphics processor and graphics processing system could be configured such that all of the, e.g. sets of lower level data, are always encoded in the same way (using the same pre-determined encoding format). In this case, the, e.g. sets of lower level data, can correspondingly be decoded using a corresponding single, and predetermined, decoding process.

However, it would also be possible for different encoding formats to be used, e.g. on a packet-by-packet basis, and/or within an individual packet (e.g. for different sub-sets of primitives within an individual packet), if desired.

Correspondingly, the same encoding format may be used for all of the sets of lower level data in a packet or different encoding formats may be used for different ones of the sets of lower level data.

In this case, the packet reading (decoding process) should correspondingly be configured and operable to use plural different decoding processes, and an indication of the decoding process to use for a given packet and/or for a respective, e.g. set of lower level data, stored in a packet, is in an embodiment appropriately conveyed to the packet reading/decoding process (circuit).

The decoding process to be used can be conveyed to the packet reading/decoding process in any suitable and desired manner. In an embodiment, this indication is provided in (conveyed by) a packet itself. An indication of the encoding format used, e.g. for one or more of the sets of lower level data, may, for example, be stored in the higher level data and/or a header, of a packet.

As discussed above, in an embodiment, the encoding of the, e.g. sets of lower level data, comprises encoding the data relative to a reference (e.g. previous) value for that lower level data. Thus in this case, decoding the encoded (e.g. lower level) data in an embodiment comprises decoding some or all of that data using a reference value for the data in question (e.g. using a previous value encoded in the packet for the data in question).

As discussed above, in an embodiment, a set of lower level data comprises a set of encoded commands, in which case reading a set of lower level data in an embodiment comprises decoding the set (e.g. sequence) of encoded commands for the set of lower level data.

In an embodiment, a set of lower level data comprises a set of commands that includes commands encoded relative to one or more other commands in the set of commands, in which case decoding the set of commands in an embodiment comprises decoding a command encoded relative to one or more other commands in the set of commands.

For example, a command for one or more primitives in a sub-set of primitives can in an embodiment be encoded relative to a command for at least one other primitive in the sub-set of primitives, in which case decoding the set of commands in an embodiment comprises decoding a command for one or more primitives in the sub-set of primitives using (based on) a command for at least one other primitive in the sub-set of primitives.

As discussed above, in embodiments, sets of lower level data are defined (e.g. encoded) independently of (without needing to use) one another. Thus, in an embodiment, the decoding process is correspondingly in an embodiment configured to, and operable to, read, and decode different sets of lower level data in a packet in any desired order relating to each other, and/or (and in an embodiment and) in parallel.

Thus, in an embodiment, when it is identified that plural sub-sets of one or more primitives (belonging to the same set of primitives) should be processed for a region of the render output, sets of lower level data for different ones of the plural sub-sets of primitives are decoded independently of (and in an embodiment in parallel with) one another.

As will be appreciated from the above, that the method of the technology described herein accordingly in an embodiment further comprises:
using bounding boxes associated with packets for a render output to identify whether any of the packets should be read for a respective region of the render output; and
when it is identified that a packet should be read for a region of the render output:
reading from the packet a set of higher level data for processing a set of primitives in the packet;
using bounding boxes associated with sub-sets of one or more primitives in the set of primitives to identify whether any of the sub-sets of one or more primitives should be processed for the region of the render output; and
for each sub-set of one or more primitives that it is identified should be processed for the region of the render output:
   reading from the packet a set of lower level data for processing the primitive or primitives in the sub-set of one or more primitives; and
   processing a primitive or primitives in the sub-set of one or more primitives using the set of higher level data and the set of lower level data.

Correspondingly, in an embodiment, the graphics processor further comprises:
a processing circuit configured to process primitives for a render output; and
a packet reading circuit configured to:
   use bounding boxes associated with packets comprising respective sets of primitives to be processed for a render output to identify whether any of the packets should be read for a respective region of a render output being generated; and
   when it is identified that a packet should be read for a region of a render output:
      read from the packet a set of higher level data for processing a set of primitives in the packet;
      use bounding boxes associated with sub-sets of one or more primitives in the set of primitives to identify whether any of the sub-sets of one or more primitives should be processed for the region of the render output; and
   for a sub-set of one or more primitives that it is identified should be processed for the region of the render output:
      read from the packet a set of lower level data for processing the primitive or primitives in the sub-set of one or more primitives; and
      provide, to the processing circuit, a primitive or primitives in the sub-set of one or more primitives to be processed, together with data to be used to process the primitive or primitives based on the set of higher level data and the set of lower level data.

The technology described herein extends to the use of primitive packets that have been generated in the manner described herein per se.

Thus a third embodiment of the technology described herein comprises a method of operating a graphics processor when performing tile-based rendering, in which a render output is divided into a plurality of tiles for rendering purposes, and in which packets are provided comprising respective sets of primitives to be processed for a render output, the method comprising:
using bounding boxes associated with packets for a render output to identify whether any of the packets should be read for a respective region of the render output; and
when it is identified that a packet should be read for a region of the render output: reading from the packet a set of higher level data for processing a set of primitives in the packet;
using bounding boxes associated with sub-sets of one or more primitives in the set of primitives to identify whether any of the sub-sets of one or more primitives should be processed for the region of the render output; and
for each sub-set of one or more primitives that it is identified should be processed for the region of the render output:
   reading from the packet a set of lower level data for processing the primitive or primitives in the sub-set of one or more primitives; and
   processing a primitive or primitives in the sub-set of one or more primitives using the set of higher level data and the set of lower level data.

A fourth embodiment of the technology described herein comprises a graphics processor operable to perform tile-based rendering, in which a render output is divided into a plurality of tiles for rendering purposes, the graphics processor operable to process packets comprising respective sets of primitives to be processed for a render output, the graphics processor comprising:
a processing circuit configured to process primitives for a render output; and
a packet reading circuit configured to:
   use bounding boxes associated with packets comprising respective sets of primitives to be processed for a render output to identify whether any of the packets should be read for a respective region of a render output being generated; and
   when it is identified that a packet should be read for a region of a render output:
      read from the packet a set of higher level data for processing a set of primitives in the packet;
      use bounding boxes associated with sub-sets of one or more primitives in the set of primitives to identify whether any of the sub-sets of one or more primitives should be processed for the region of the render output; and
   for a sub-set of one or more primitives that it is identified should be processed for the region of the render output:
   read from the packet a set of lower level data for processing the primitive or primitives in the sub-set of one or more primitives; and
   provide, to the processing circuit, a primitive or primitives in the sub-set of one or more primitives to be processed, together with data to be used to process the
primitive or primitives based on the set of higher level data and the set of lower level data.

As will be appreciated by those skilled in the art, these embodiments of the technology described herein can, and in an embodiment do, include any one or more or all of the optional features of the technology described herein, as appropriate.

Thus, for example, the packet reading process (circuit) can, and in an embodiment does, comprise any of the optional features of that process as discussed above.

Thus, in the case where a given sub-set of primitives corresponds to a single primitive only, then the primitive in question is in an embodiment processed using the set of higher level data for the set of primitives that the primitive belongs to and the set of lower level data for the primitive in question, that is indicated by the packet.

On the other hand, in the case when it is identified that a sub-set of primitives comprising a group of plural primitives should be processed for a respective region of a render output, it is in an embodiment then identified which primitive or primitives in the group (in the sub-set) of plural primitives should be processed (and which primitives (if any) in the group (sub-set) need not be processed) for the region.

Again, which primitives in a sub-set of primitives should be processed for a respective region of a render output is in an embodiment determined using bounding boxes associated with (for) (e.g. bounding) (the) individual primitives (which bounding boxes are in an embodiment stored in the packet comprising the sub-set of primitives, and in an embodiment in the packet in (as) a set of lower level data for the sub-set of primitives).

Thus, in an embodiment, for a (and in an embodiment for each) sub-set of primitives comprising a group of plural primitives that it is identified should be processed for a region of a render output, a set of lower level data for processing the group of plural primitives is read from the packet in question, it is identified whether any of (and which if any of) the primitives in the group of plural primitives should be processed for the region of the render output (in an embodiment using the set of lower level data), and when it is identified that one or more primitives in the group of plural primitives should be processed for the region of the render output, the one or more primitives are processed using the set of lower level data for the sub-set of primitives and a set of higher level data for the set of primitives comprising the sub-set of primitives.

Correspondingly, in embodiments, the sets of lower level data are stored in a packet in an encoded format and the reading of the relevant lower level data comprises decoding the lower level data accordingly, in an embodiment using a reference value for the data in question (e.g. using a previous value encoded in the packet for the data in question).

Similarly, reading a set of lower level data in an embodiment comprises decoding a set (e.g. sequence) of encoded commands for the set of lower level data, in an embodiment including decoding a command encoded relative to one or more other commands in the set of commands.

In embodiments, the decoding process is configured to, and operable to, read, and decode, different sets of lower level data in a packet in any desired order relating to each other, and/or (and in an embodiment and) in parallel.

Correspondingly, the packets are in an embodiment generated in accordance with the first and second embodiments of the technology described herein discussed above, and accordingly in an embodiment comprise any one or more of the optional features of those embodiments of the technology discussed herein, as appropriate. Thus, for example, and in an embodiment, the set(s) of higher level data for a packet and the set or sets of lower level data for a packet are in an embodiment configured and/or encoded as discussed above.

A primitive that is to be processed for a region (e.g. tile) of a render output (based on, and using, the respective set of higher level data and set of lower level data for the primitive) can be processed in any suitable and desired manner (and a (the) (primitive) processing circuit can be configured to and operable to process primitives (based on, and using, the respective set of higher level data and set of lower level data for the primitive) in any suitable and desired manner).

In an embodiment, this processing comprises (at least) performing appropriate rendering and fragment processing for the primitive. The rendering/fragment processing may comprise, for example, appropriate fragment shading for the primitive. The rendering/fragment processing may comprise, for example, rasterising primitives to fragments and then performing fragment shading for the fragments. The rendering/fragment processing for a primitive may also instead comprise (performing) ray-tracing, or hybrid ray-tracing, if desired.

The rendering/fragment processing in an embodiment generates appropriate rendered output data values (e.g. RGB or RGBA values) for a primitive and for the tile of the render output that is being rendered. The output rendered data may then be appropriately written out, e.g. to memory, for the render output in question.

Other arrangements would, of course, be possible.

The above describes the particular elements of the graphics processor and graphics processing pipeline that are involved in the operation in the manner of the technology described herein. As will be appreciated by those skilled in the art, the graphics processor and graphics processing pipeline can otherwise include, and in an embodiment does include, and execute, any one or one or more, and in an embodiment all, of the other processing circuits/stages that graphics processors may (normally) include.

Thus, for example, the graphics processor and pipeline in an embodiment also includes one or more of, and in an embodiment plural of, and in an embodiment all of: one or more shader stages/circuits (such as a vertex shader or shaders); one or more (early and/or late) culling (e.g. depth and/or stencil) testers (culling (e.g. depth and/or stencil) test stages), a blender (blending stage), etc.

Other arrangements for the graphics processing that is being executed would, of course, be possible.

The render output to be generated may comprise any render output that can be and is to be generated by a graphics processor and processing pipeline, such as a frame for display, a render-to-texture output, etc. In an embodiment, the render output is an output frame, and in an embodiment an image.

In an embodiment, the various functions of the technology described herein are carried out on a single graphics processing platform that generates and outputs the (rendered) data that is, e.g., written to a frame buffer for a display device.

In embodiments, the graphics processor comprises, and/or is in communication with, one or more memories and/or memory devices that store the data described herein, and/or that store software for performing the processes described herein.

The graphics processor may also be in communication with a host microprocessor, and/or with a display for displaying images based on the output of the graphics processor.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuits of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described.

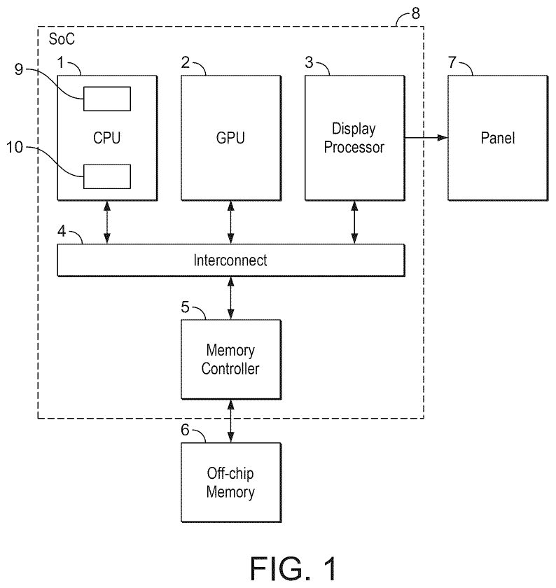

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

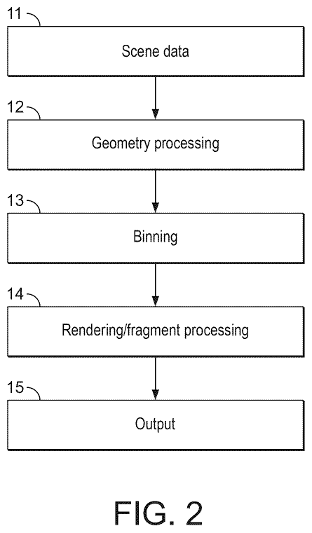

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices. It would also be possible for some or all the (non-position) vertex shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 2, a binning/tiling stage 13. In this regard, the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.

The binning process operates to generate appropriate data structures for determining which primitives need to be processed for respective rendering tiles of the output being generated. In the present embodiments, the data structures are hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc.,

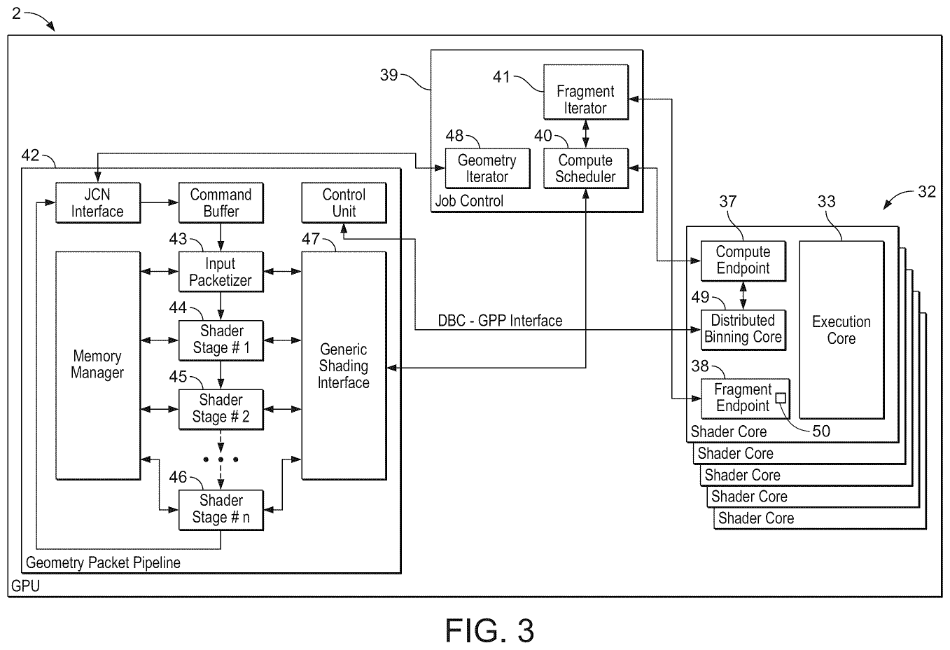

FIG. 3 shows an embodiment of a graphics processor (GPU) 2 that can execute a graphics processing pipeline of the form shown in FIG. 2, and that can be operated in the manner of the technology described herein.

As shown in FIG. 3, the graphics processor 2 comprises a plurality of processing (shader) cores 32 which are each operable to execute (shader) programs to perform processing operations. As shown in FIG. 3 each shader core 32 to facilitate this comprises a programmable execution unit (execution core/processing circuit) 33 that is operable to execute program instructions to perform processing operations.

In the present embodiments, the shader cores 32 are operable to execute both “compute” shader programs (to perform so-called compute shading) and fragment shader operations. Thus as shown in FIG. 3, each shader core 32 comprises an appropriate compute endpoint 37 and fragment endpoint 38 that act as the control interface for performing compute shading and fragment processing, respectively, and that will, for example, and in an embodiment, trigger the execution core 33 to execute the appropriate compute shading or fragment shading tasks, as required.

As shown in FIG. 3, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will typically be an initial geometry processing stage that determines the vertex and other data that is necessary for generating the graphics processing output in question, which will then be followed by a rendering/fragment processing stage for processing (rendering) that geometry.

In the present embodiments, the geometry processing is performed, as shown in FIG. 3, by a geometry packet pipeline 42 of the graphics processor 2. This geometry packet pipeline is operable to trigger the performance of one or more “geometry” shader stages (which shader stages themselves will be executed by the shader cores 32, under the control of the geometry packet pipeline 42).

For example, as shown in FIG. 3, the geometry packet pipeline 42 comprises an input packetizer 43 (packet generating circuit) that can generate initial geometry packets and trigger position shading and vertex shading by the shader cores 32. It also includes further shader stage circuits 44, 45, 46 that are operable to trigger compute shaders for performing geometry processing, such as task shaders, mesh shaders, tessellation shaders, etc. (which again will be executed by the shader cores 32).

As shown in FIG. 3, the geometry packet pipeline 42 has an appropriate interface 47 to the compute scheduler 40 of the job control unit 39, via which it can control and trigger the performance of appropriate geometry shading operations by the shader cores 32.

The overall operation of the geometry packet pipeline 42 is controlled by the job control unit 39 (by a geometry iterator 48 of the job control unit 39) which distributes the appropriate geometry processing jobs and tasks to the geometry packet pipeline 42.

The graphics processor 2 of FIG. 3 is configured to perform rendering in a tile-based manner (as discussed above). To facilitate this, as shown in FIG. 3, each shader core 32 also includes a distributed binning core 49 that is operable to generate appropriate data structures for determining which primitives need to be processed for respective rendering tiles of the output being generated.

In the present embodiments, the distributed binning cores 49 generate hierarchies of bounding boxes for primitives and primitive packets (that contain primitives to be rendered) (which are then used at the rendering/fragment processing stage to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

The distributed binning cores 49 of the shader cores 32 may trigger vertex shading, such as varying shading, as part of their operation (e.g. where varying shading was not performed by the input packetizer as part of the input packetizer 43 operation).

In the present embodiments, the rendering/fragment processing is performed by executing appropriate fragment processing operations on a shader core 32 under the control of the fragment endpoint 38. To facilitate this, the fragment endpoint 38 of each shader core is operable to trigger appropriate fragment shader operation by a shader core.

As will be appreciated from the above, in operation of the present embodiments, the geometry packet pipeline 42 that performs the geometry processing will generate appropriate geometry data, such as (transformed) vertex positions, vertex non-position varyings, and primitive attributes, which data will then be used, for example, by the binning/tiling processing and rendering/fragment processing of the later stages of the graphics processing pipeline.

In the present embodiments, the geometry packet pipeline 42 operates to generate respective geometry packets containing the data that it generates. In the present embodiments, those geometry packets are then processed by the distributed binning cores 49 to generate corresponding primitive packets, which primitive packets are then read (by a packet reading circuit 50) and used by the fragment processing (fragment endpoint) 38.

Thus, in the present embodiments, the geometry packet pipeline 42 will generate geometry packets that store attributes for vertices and primitives, which geometry packets will then be read and used by the distributed binning cores 49.

Correspondingly, the distributed binning cores 49 will generate appropriate primitive packets storing attributes for vertices and primitives, which primitive packets will then be read and used by the fragment processing 38.

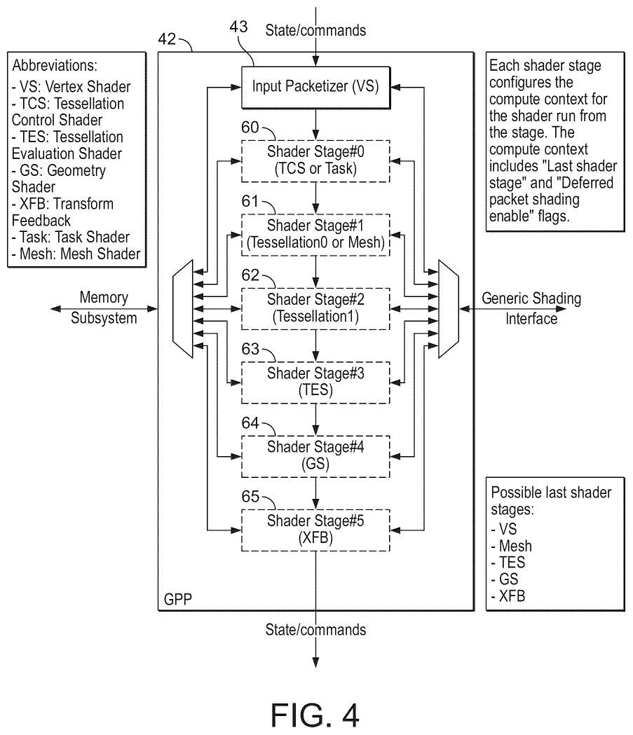

FIG. 4 shows the geometry packet pipeline 42 of the present embodiments in more detail.

As shown in FIG. 4, in the present embodiments the geometry packet pipeline 42 comprises (can trigger the execution of) (up to) six shader stages, an input packetizer 43 (that can trigger vertex shading (VS)); a next shader stage 60 that can trigger tessellation control shading or task shading; a next shader stage 61 that can trigger tessellation shading or mesh shading; a next shader stage 62 that can trigger further tessellation shading; a next shader stage 63 that can trigger tessellation evaluation shading; a next shader stage 64 that can trigger geometry shading; and a final shader stage 65, that can trigger transform feedback shading.

In the present embodiments, when executing the geometry packet pipeline for a render output (e.g. for a draw call), the various shader stages shown in FIG. 4 can be selectively enabled. In other words, not every execution of the geometry packet pipeline 42 will include all the shader stages shown in FIG. 4, but selective shader stages can be omitted from the geometry packet pipeline 42 that is being executed.

In any event, and irrespective of any preceding shader stages that are activated, in the present embodiments, the shader stages that can potentially be the last shader stage of any given geometry processing pipeline are the vertex shader (input packetizer 43); the mesh shader (shader stage 61), the tessellation evaluation shader (stage 63), the geometry shader (stage 64) and the transform feedback shader (stage 65).

One of these shader stages will always be the last shader stage in a given geometry packet pipeline that is being executed in the embodiments of the technology described herein. (Any shader stages that are omitted in the geometry packet pipeline actually being executed are disabled, so that packets will, in effect, simply pass through those stages without being processed.)

In operation, each shader stage of the geometry packet pipeline 42 will configure the compute context for the shader that is run from the stage in question. In the present embodiments, the compute context that is configured for a (and each) shader stage includes an indication of whether the shader stage in question is the last shader stage for the geometry processing pipeline being executed, and whether “deferred packet shading” to defer some of the (non-position) vertex shading for a packet to a later stage has been enabled or not. In the present embodiments, the compute context for each shader stage includes appropriate flags that can be set to indicate this.

In the present embodiments, the first, input packetizer stage 43 of the geometry pipeline 42 of the present embodiments generates respective initial geometry packets storing data for sets of primitives to be processed for the render output being generated.

To do this, the input packetizer 43 assembles primitives using lists of vertex indices indicating vertices to be used to assemble primitives for the render output being generated based on appropriate primitive configuration information indicating how the lists of vertices should be assembled into primitives, and then assigns the assembled primitives to packets in order. In the present embodiments, a packet has a fixed capacity, e.g. an upper limit of vertices and/or primitives, and when the fixed capacity is reached, a new packet is started. Appropriate memory space for storing a packet is also allocated.

The (geometry) packets generated by the input packetizer 43 are then passed to the next (enabled) shader stage (if any) for processing, with that shader stage then performing appropriate processing of the packets that it receives and generating corresponding output packets, which are then passed on to the next shader stage of the geometry packet pipeline 42 (if any), and so on, until the final shading stage of the geometry packet pipeline being executed is reached (which as discussed above will be indicated as such).

In the present embodiments, when the last shader stage of the geometry packet pipeline being executed is reached for a packet, a packet shading request is sent for the last shader of the geometry packet pipeline to be executed for the packet, but rather than the last shader of the geometry packet pipeline being executed simply being executed on the shader cores 32 for the packet, the packet is instead first processed by a distributed binning core 49 of a shader core.

In particular, the “last” shader stage packet shading request for a packet is sent to the compute endpoint 37 of the shader core 32 in question which then signals the distributed binning core 49 accordingly.

The distributed binning core 49 then determines whether to defer the final shader stage of the geometry packet pipeline for the packet, or perform that last shader stage of the geometry packet pipeline being executed for the packet immediately.

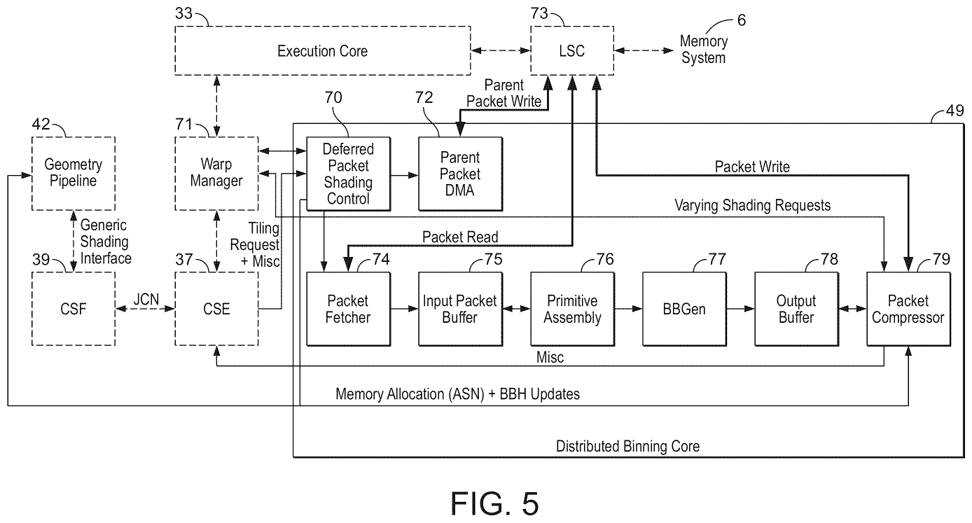

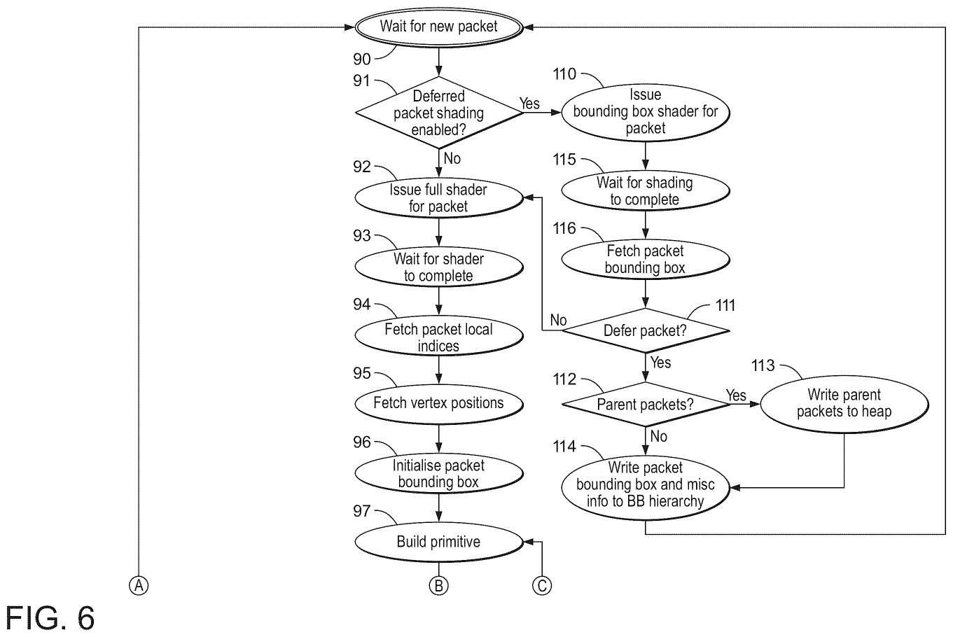

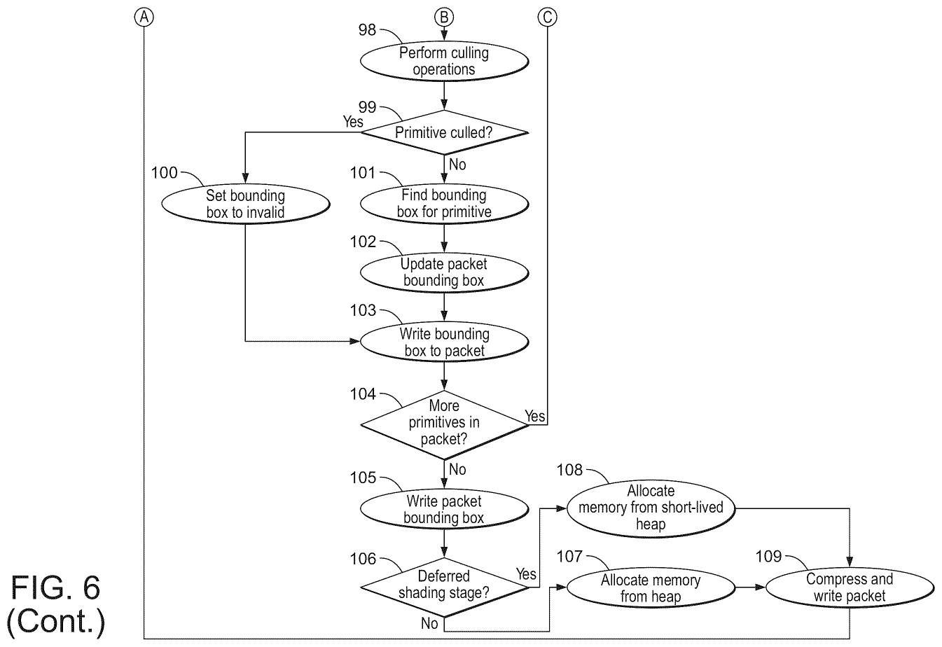

FIGS. 5 and 6 show the operation of a distributed binning core 49 in this regard in the present embodiments. FIG. 5 is a block view of a distributed binning core 49 showing elements of that core that are relevant to this operation. FIG. 6 is a flow chart showing the distributed binning core operation in the present embodiments.

As shown in FIG. 5, the distributed binning core includes a deferred packet shading control unit/circuit 70 that receives appropriate processing requests from the compute shader endpoint 37 when a last shader stage is to be executed for a packet.

As will be discussed further below, the deferred packet shading control 70 determines whether the last shading stage for the packet should be deferred or not, and then either triggers the shading for the packet, or defers that shading, accordingly. As shown in FIG. 5, to facilitate this, the deferred packet shading control unit 70 has an appropriate interface to a warp manager 71 for issuing shading processing to its associated execution core 33.

The deferred packet shading control unit 70 also controls a “parent packet” DMA unit 72 that is operable to write the “parent” packet (i.e. the geometry packet that is still to undergo its last shading stage) to memory (via, for example, a load store cache 73 of the shader core) in the case where the last shading stage is deferred (as if the last shading stage is deferred, the “parent” packet for that shading stage will be required for executing that shading stage later on in the processing (in a deferred manner)).

As shown in FIG. 5, the distributed binning core 49 includes an appropriate packet processing pipeline (packet generating circuit), which is used to generate appropriate primitive packets for processing by the rendering/fragment processing from the geometry packets that it receives, and to also generate the appropriate data structures (which in the present embodiments are hierarchies of bounding boxes for packets) to allow the rendering/fragment processing to determine which packets need to be processed for a given rendering tile.

Thus as shown in FIG. 5, the distributed binning core packet processing pipeline comprises a packet fetcher 74 which is operable to fetch packets to be processed from the memory, and an input packet buffer 75 for buffering the packets while they are processed. A primitive assembly stage (circuit 76) is operable to assemble primitives in packets and, where appropriate, perform culling operations for the primitives. The assembled primitives (that are not culled) are then passed to a bounding box generating stage/circuit 77, with the processed primitives, etc., then being stored in an output buffer 78 until the relevant primitive packet is completed (at which point the packet will be compressed by a packet processing stage/circuit 79 and then written out to memory).

As shown in FIG. 5, the distributed binning core can also trigger vertex varying shading for vertices in a packet, if required, for example where that has not been performed as part of the geometry packet pipeline execution.

FIG. 6 shows the operation of the distributed binning core 49 when a packet shading request for the last shader of the geometry packet pipeline being executed is received for a packet.

As shown in FIG. 6, when such a shading request for a packet is received (step 90), it will first be determined whether deferred packet shading has been enabled (step 91).

If deferred packet shading has not been enabled then the last shading stage of the geometry packet pipeline being executed will be performed immediately (triggered by the deferred packet shading control 70 of the distributed binning core).

Thus in this case, the full shader (the last shading stage for the geometry packet pipeline) will be issued and executed (step 92) for the packet in question. Then, once that shading has been completed (step 93), the distributing binning core will process the “finished” geometry packet to derive a bounding box for the packet and for the primitives in the packet and to cull any primitives in the packet that can be culled, etc..

For this processing, as shown in FIG. 6, first the indices for the vertices in the (completely geometry processed) geometry packet will be fetched (step 94). The vertex positions for the vertices in the packet will correspondingly be fetched (step 95), and a bounding box for the packet initialised (step 96).

The process will then build each primitive in the packet (step 97) in turn, and determine if the primitive can be culled (step 98). If a primitive is culled (step 99), then the bounding box for the primitive is set to be invalid (step 100) (to indicate that the primitive has been culled), and that (invalid) bounding box is written to the primitive packet accordingly (step 103).

On the other hand, if the primitive is not culled (step 99), then a bounding box for the primitive is determined (step 101). The bounding box for the packet is updated based on the primitive bounding box (step 102), and the bounding box for the primitive is written to the packet (step 103).

If there are more primitives in the packet, then the process is repeated until all the primitives for the packet have been processed (step 104).

Once all the primitives in the packet have been processed, then the overall bounding box for the packet is written to the packet bounding box hierarchy, as appropriate (step 105). As discussed further below, the packet is then encoded by generating sequences of commands representing respective groups of primitives within the packet, and the packet is written out to memory (step 109).

As shown in FIG. 6, in the case where the last stage of geometry shading for a packet is not being deferred (so is being performed immediately) then the packet is encoded and written to a “long-term” heap in memory (steps 106 and 107).

As shown in FIG. 6, in the case where deferred packet shading is enabled at step 91, then the process first determines a bounding box for the packet in question.

This packet bounding box can be determined in any suitable and desired manner.

This may, as discussed above, be based on and use information provided by the application that is requesting the graphics processing, and/or use appropriate position information for the packet from preceding geometry processing stages that have been performed for the packet, and/or be determined by executing an appropriate position shading (bounding box shader) for the packet that determines a bounding box for the packet (but does not otherwise perform any geometry processing, e.g. that is to be deferred for the packet).

In the case where the bounding box for a packet is then determined by running a bounding box shader for the packet (as shown in FIG. 6), the distributed binning core will issue the bounding box shader (step 110) and wait for the shading to be complete (step 115), and then fetch the packet bounding box that has been generated as a result of the bounding box shader (step 116).

Thus, if necessary, the deferred packet shading control triggers a process to appropriately generate a bounding box for a packet (and then fetches the bounding box for the packet). Alternatively, where the bounding box for the packet is already available, it will simply fetch the bounding box for the packet.

The deferred packet shading control 70 will then determine whether to defer the final geometry packet pipeline shading stage for the packet or not (step 111). In the present embodiment, this decision is based on a count of how many packets have already been deferred for the render output in question. Other arrangements would, of course, be possible.

As shown in FIG. 6, in the case that it is decided not to defer the final geometry packet pipeline shading stage for the packet at step 111, then the full shader is issued for the packet at step 92 and the process discussed above is followed for the packet.

On the other hand, when it is decided to defer the final geometry packet pipeline shading stage for the packet, it is then determined whether the packet whose processing is being deferred has any relevant parent packets that would be needed when performing the deferred processing (step 112). If so, the deferred packet shading control 70 causes the required parent packets to be written appropriately to memory (step 113).

As shown in FIG. 6, the distributed binning core operation will then write the packet bounding box and any other information (e.g. state) required for performing the deferred packet shading at a later time into the bounding box hierarchy structure that it is generating for the render output in question (step 114).

The process then waits for the next packet to be processed (step 90), and so on.

Once all the packets for a render output (e.g. draw call) being processed have reached the last stage of the geometry processing pipeline being executed and correspondingly being processed by a distributed binning core in the manner illustrated in FIG. 6, then the distributed binning core(s) will have generated, between them, an appropriate binning data structure or structures that can be used to determine which packets for the render output should be processed for respective rendering tiles of the render output.

In the present embodiments, the binning data structures generated by the distributed binning cores comprise appropriate bounding box hierarchies, against which respective rendering tiles can be tested to determine whether a packet should be processed for the rendering tile or not.

However, as discussed further below, in the present embodiments, when it is determined that a packet should be processed for a rendering tile, it can be further determined which group(s) of primitives within a packet, and which individual primitive(s) within a group of primitives, should be processed for a rendering tile or not.

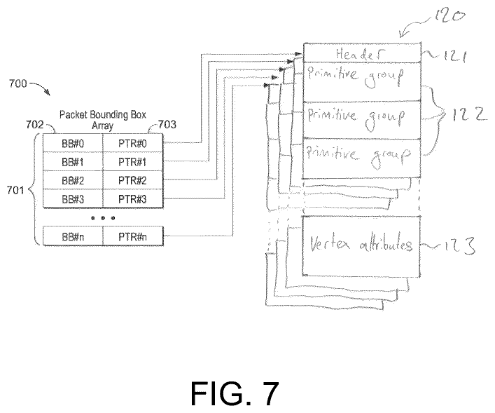

FIG. 7 shows the memory layout and content for an exemplary encoded packet 120 that may have been generated by a distributed binning core 49, and that is usable to identify primitives in the packet 120 that should be processed (or not) for a rendering tile.

The packet 120 comprises a header 121 from which configuration data can be decoded that is applicable for processing all of the primitives in the packet. In this regard, the configuration data itself may be stored in the header 121, the header 121 may comprise a pointer to where the configuration data is stored in memory, or some of the configuration data may be stored in the header 121 and a pointer provided in the header 121 to the remaining configuration data for the packet 120. For example, configuration data that is likely to vary between packets may be stored in the header but other configuration data that is likely to be common to many packets can be stored separately and a pointer to that other configuration data stored in the header 121 together with a flag set to indicate that the other configuration data is required.

The configuration data may be set per draw call, and may indicate, for example, a scissor box to be used when performing a scissoring operation, a depth range, and/or a line width.

The header 121 also stores primitive group bounding boxes for groups of one or more primitives 122 stored in the packet. The primitive group bounding boxes are in an embodiment encoded, and in an embodiment encoded relative to the packet bounding box for the packet and/or relative to one another. The header 121 further stores an indication that allows the data for particular primitive groups 122 to be located within, and read from, the packet 120.

For each primitive group 122, a sequence of commands is stored that encodes bounding boxes for individual primitives within a group, vertex indices (vertex IDs) that reference vertices to define individual primitives, and any other attributes used to indicate how individual primitives within the groups 122 should be processed. In the present embodiments, as explained further below, each sequence of commands comprises commands encoded relative to one another, such that the sequence of commands should be read in order to decode the data required for individual primitives. However, the sequences of commands for different primitive groups 122 are independent of one another to allow the sequence of commands for any particular primitive group to be read without requiring the sequence of commands for any preceding primitive groups to be read first.

Accordingly, the header 121 can be read to identify a primitive group or groups 122 that should be processed for a rendering tile using the primitive group bounding boxes, and the sequence of commands for any primitive group 122 that it is identified should be processed for a rendering tile can then be read and used to process primitives for the rendering tile. When processing the primitives within a primitive group 122, the primitive bounding boxes encoded in the sequence of commands can be used to determine which primitives are required for the rendering tile (and when a primitive is determined to not be required, that primitive can be culled (discarded) during the processing for the tile in question).

The packet 120 further stores vertex attribute data 123 (for vertex positions and other attributes/varyings) for vertices that represent primitives within the packet, where the vertex attributes for a particular primitive are identifiable using the vertex indices for the primitive. Other arrangements of a packet 120 would, of course, be possible.

FIG. 7 also shows, by way of example, a packet bounding box array 700 of a binning data structure. The packet bounding box array 700 includes a number of entries 701 that each include a respective pointer 703 pointing to the respective packet 120 in memory, and a packet bounding box (bounding box information) 702 for the packet in question.

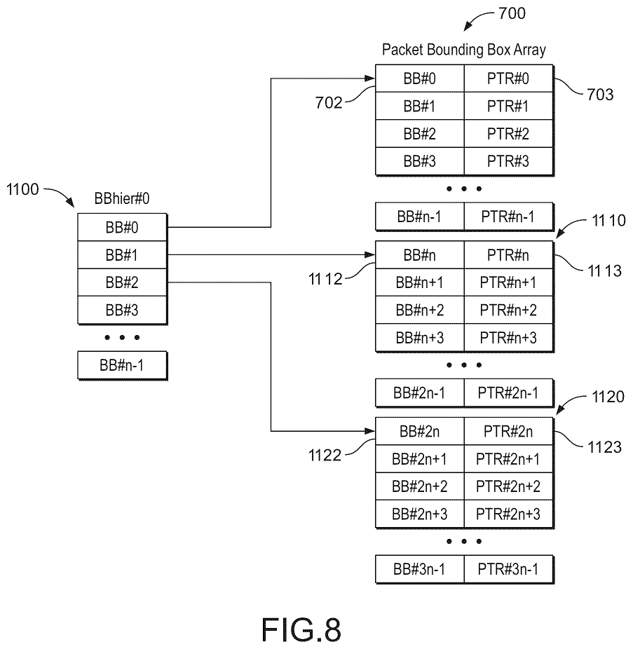

FIG. 8 shows a bounding box hierarchy of a binning data structure that comprises higher hierarchy levels compared to the packet bounding box array.

As illustrated in FIG. 8, a bounding box hierarchy array 1100 may be maintained, with each entry of the array comprising a pointer pointing to an array defining bounding boxes for a respective level of the bounding box hierarchy. As illustrated in FIG. 8, in this embodiment, the first entry of the bounding box hierarchy array 1100 points to the packet array 700 shown in FIG. 7.

A higher level of the bounding box hierarchy may be generated by iterating through the packet array 700 and generating from the packet bounding boxes 702, bounding boxes for groups of, e.g. two, four, eight (or another number), packets. As illustrated in FIG. 8, these (larger) bounding boxes may be stored in entries of higher-level array 1110, wherein each entry of the array 1110 comprises a respective, “higher level” bounding box 1112, and pointers 1113 pointing to the packet array 700 entries for the packet bounding boxes from which the “higher level” bounding box was generated.

Further levels of the bounding box hierarchy may be generated in an analogous manner. For example, FIG. 8 shows a higher-still level of the bounding box hierarchy generated by iterating through array 1110 and generating from the bounding boxes 1112, larger bounding boxes, which are stored in entries of array 1120, wherein each entry of the array 1120 comprises a respective, higher level bounding box 1122, and pointers 1123 pointing to the corresponding next lower level array 1110 entries. Further levels of the bounding box hierarchy may be generated up to a “highest” level which may comprise a single bounding box that encompasses all primitives of all packets, e.g. for the draw call/render output in question.

Once the necessary binning data structures for the render output (e.g. draw call) being processed have been generated by the distributed binning cores, then the rendering/fragment processing of the render output in question can be performed.

In the present embodiments, the rendering/fragment processing is triggered and controlled by the fragment iterator 41 issuing appropriate fragment shading (rendering) tasks to the fragment endpoints 38 of the shader cores, with the fragment endpoints then triggering appropriate fragment shading etc., on the execution cores, accordingly.

In the present embodiments, the triggering and control of the rendering/fragment shading by the fragment iterator is also operable to determine whether any geometry shading has been deferred for packets to be processed for tiles, and to, if so, trigger the performance of the deferred geometry processing for a packet, before the rendering/fragment processing for a tile using the packet is performed.

Deferred geometry processing for a packet can generate an encoded packet and updated binning data structure (bounding box hierarchy) for the packet in the manner discussed above with reference to FIG. 6 to generate the appropriate encoded packet and update the corresponding binning data structure (bounding box hierarchy) accordingly. The binning stage also in an embodiment correspondingly sets the packet as not (no longer) having any geometry processing “deferred” for it in the updated binning structure, so that when the updated binning structure is used, the packet will be seen as being “complete”, and not needing further geometry processing to be performed for it (as that further geometry processing will now have been done).

As shown in FIG. 6, in this case, as the processing is being performed at the deferred shading point (step 106), the encoded packet that has been generated by the distributed binning core after the deferred shading has been performed is stored in a “short-lived” heap in memory (steps 108 and 109) (rather than being stored in a longer-term memory heap).

Once an appropriate run fragment command has been sent to the task issuer, the task issuer will then issue appropriate rendering/fragment processing tasks to the fragment endpoints 38 of the shader cores 32 for respective rendering tiles accordingly.

The tasks will indicate an appropriate set of one or more tiles to be rendered by the shader core in question, together with an indication of the rendering/fragment processing that is to be performed for the tiles. The fragment endpoint 38 will then use the binning data structures generated by the distributed binning cores to identify the packet or packets to be processed for a tile that they are processing. As discussed further below, when a packet is identified as being a packet to be processed for a tile then the packet is decoded and bounding boxes for respective primitives and groups of primitives within the packet are used to identify the primitives in the packet to be processed for the tile in question, and appropriate rendering/fragment processing for the identified primitives is performed to process the tile in question.

The rendering/fragment processing that is performed for primitives and for a tile can comprise any suitable and desired rendering/fragment processing that can be performed, such as rasterising primitives to fragments and then performing fragment shading for the fragments, and/or performing ray tracing operations, etc..

Once a shader core has processed a tile, that tile will be written out to memory and the shader core will process the next tile (if any) that it is to process, and so on. This will be continued until the render output in question has been entirely generated.

This process will then be repeated for the next render output, and so on.

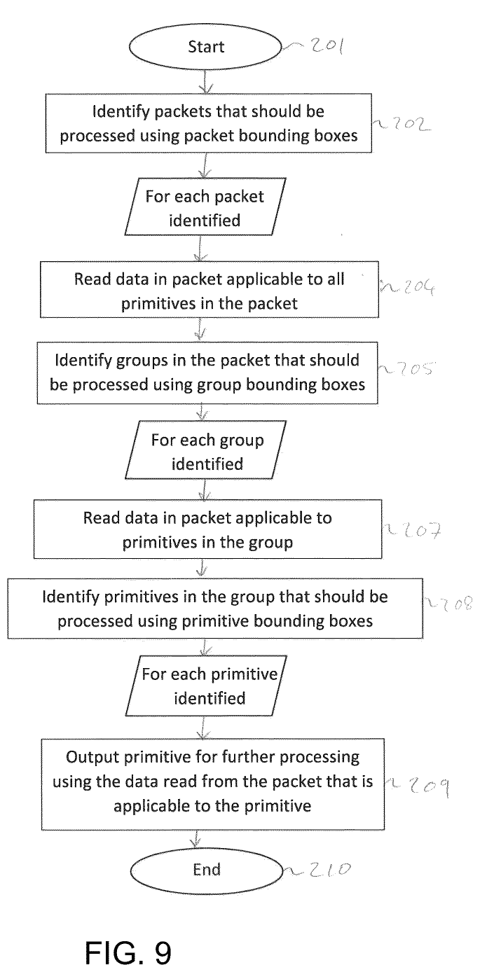

FIG. 9 shows an operation used to identify primitives that should be processed for a tile being processed by a shader core 32.

As shown in FIG. 9, the operation begins when a new tile is being processed by a shader core 32 (step 201). To identify primitives that should be processed for the tile, packets that should be processed for the tile are identified (step 202). The packets that should be processed are identified using bounding boxes of the binning data structures. This can be carried out by determining whether or not bounding boxes intersect with the tile when traversing the hierarchy of bounding boxes described above in relation to FIGS. 7 and 8, wherein it is identified that a packet should be processed for the tile when the packet bounding box for the packet intersects with the tile.

For each packet that it is identified should be processed for the tile, data is read from the packet header that is applicable to all of the primitives in the packet (step 205), and group bounding boxes for groups of primitives are decoded from the header and used to identify whether groups of primitives should be processed for the tile (step 205) based on which of the group bounding boxes (if any) intersect with the tile.

For each group of primitives that it is identified should be processed for the tile, data applicable to primitives in the group is read from the packet (step 207). In the present embodiments, data for a group of primitives takes the form of a sequence of commands, where the sequence of commands comprises commands applying to plural primitives in the group and commands applying to individual primitives in the group. The sequence of commands also encodes primitive bounding boxes for individual primitives in the group, and the primitive bounding boxes are used to identify whether primitives should be processed (further) for the tile based on which of the primitive bounding boxes (if any) intersects with the tile.

When it is identified that a primitive should be further processed for the tile, that primitive is output for further processing (step 209) with the data from the packet that is applicable to the primitive and that is to be used for further processing the primitive. The data applicable to processing the primitive is identified based on the data read from the packet header that is applicable to all of the primitives in the packet, as well as the commands applicable to the primitive in the sequence of commands for the group of primitives that contained the primitive in question. The operation then ends when all of the primitives that should be processed for the tile (from each of the identified group(s) and packet(s)) are identified and output (step 210).

Accordingly, the packet bounding boxes, group bounding boxes and primitive bounding boxes can be used to identify which primitives should be processed for a tile and which data in the packets is applicable to the identified primitives. By identifying primitives that should be processed for a tile in this manner, packets that should be processed for a tile can be fetched and decoded without it being required to fetch and decode other packets that are not required for processing the tile. Furthermore, by identifying group(s) of primitives that include primitive(s) that should be processed, data for the identified group(s) of primitives can be read without it necessarily being required to read the data for all of the groups of primitives in the packet, and the primitive bounding boxes can be used to identify primitives that should be processed for a tile to determine which commands in the data for a group of primitives are applicable to the primitive(s) in the group that should be processed for a tile.

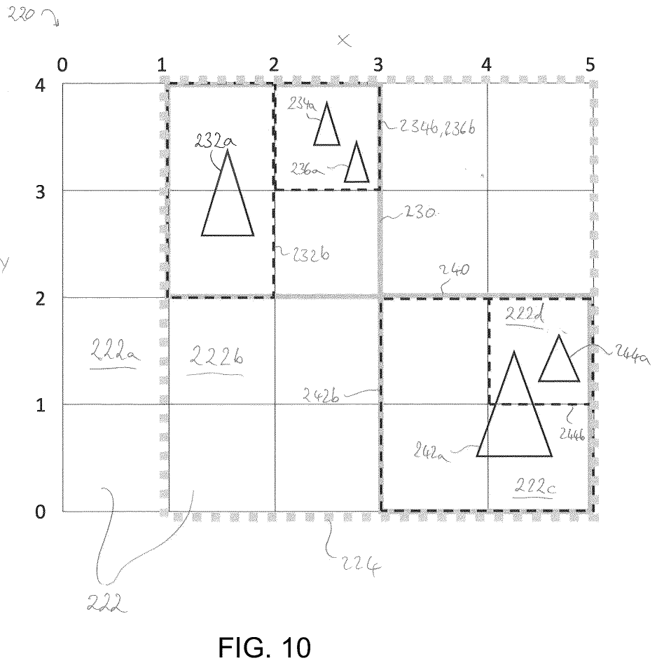

FIG. 10 shows an exemplary set of primitives that is represented by a primitive packet for a render output 220, together with a corresponding hierarchy of bounding boxes for the set of primitives in accordance with an embodiment. It will be appreciated that FIG. 10 is simplified for illustrative purposes, and in practice there may be (many) more primitives and bounding boxes defined for a render output.

The render output 220 is divided into an array of 5×4 tiles 222 for rendering purposes, defined across two dimensions (x and y). Any other suitable number and configuration of tiles 222 would, of course, be possible.

In the present embodiment, the bounding boxes in the hierarchy of bounding boxes are all either square or rectangular, and are each defined with four components (ymax, xmax, ymin, xmin), with a component for the minimum position of the bounding box and a component for the maximum position of the bounding box in each of the two dimensions (x and y) within which the render output 220 is defined. The values for the components (the bounding box position) are defined and expressed in terms of the tile positions within the render output, such that each bounding box bounds a whole number of tiles 222. Other arrangements, would of course be possible.

The hierarchy of bounding boxes includes a packet bounding box 224 that bounds all of the primitives in the set of primitives, and has components (ymax=4, xmax=5, ymin=0, xmin=1).

The hierarchy of bounding boxes also includes two group bounding boxes 230, 240 for two respective sub-sets of primitives within the set of primitives. The first sub-set of the primitives comprises three primitives 232a, 234a, 236a, and the second sub-set of primitives comprises two primitives 242a, 244a. The group bounding box 230 for the first sub-set of primitives bounds the three primitives 232a, 234a, 236a in the first sub-set of primitives and has components (ymax=4, xmax=3, ymin=2, xmin=1). The group bounding box 240 for the second sub-set of primitives bounds the two primitives 242a, 244a in the second sub-set of primitives and has components (ymax=2, xmax=5, ymin=0, xmin=3).

The hierarchy of bounding boxes also includes a primitive bounding box for each primitive in the set of primitives, such that there are three primitive bounding boxes 232b, 234b, 236b for the three primitives 232a, 234a, 236a in the first sub-set of primitives and two bounding boxes 242b, 244b for the two primitives 242a, 244a in the second sub-set of primitives. In the first sub-set of primitives, the primitive bounding boxes 234b, 236b for two of the primitives 234a, 236b have the same values for the four bounding box components (ymax=4, xmax=3, ymin=3, xmin=2). In the second sub-set of primitives, the primitive bounding box 242b for primitive 242a has the same values for the four bounding box components (ymax=2, xmax=5, ymin=0, xmin=3) as the group bounding box 240 for the second sub-set of primitives.

A packet for the set of primitives stores a higher level set of data comprising data for all of the primitives in the set of primitives and two lower level sets of data, with one lower level set of data for each of the two sub-sets of primitives, and each lower level set of data comprising data for the primitives in the sub-set of primitives that the lower level set of data is for. Providing hierarchical data and bounding boxes in this manner can allow the primitive data needed for processing particular tiles to be efficiently identified and read.

For example, to process tile 222a, the tile can be tested against the packet bounding box 224 and determined to not intersect with the packet bounding box 244 such that it is thereby determined that the packet associated with the packet bounding box 244 is not required to process the tile 222a.

To process tile 222b, the tile can be tested against the packet bounding box 224 and determined to intersect with the packet bounding box 224. However, by then testing the tile 222b against the group bounding boxes 230, 240 it can be determined that neither of the group bounding boxes 230, 240 intersect with the tile 222b such that it can be identified that at least neither of the lower level sets of data are required to be read to process the tile 222b (the higher level set of data may at least be begun to be read when it is determined that the packet bounding box 224 intersects with the tile 222b, for example to determine the group bounding boxes 230, 240 to be tested).

To process tile 222c, the tile can be tested against the packet bounding box 224 and determined to intersect with the packet bounding box 224. The tile 222c can then be tested against the two group bounding boxes 230 and 240 determined to intersect with the group bounding box 240 for the second sub-set of primitives but not the group bounding box 230 for the first sub-set of primitives. The tile 222c can then be tested against the primitive bounding boxes 242b, 244b for the two primitives 242a, 244a in the second sub-set of primitives and found to intersect with one of the primitive bounding boxes 242b but not the other 244b. Accordingly the higher level set of data for the set of primitives and the lower level set of data for the second sub-set of primitives will be read to process the tile 222c, and primitive 242a (but not primitive 244a) will be output to be processed to process the tile.

To process tile 222d, the same process will be applied as for tile 222c, other than when testing the primitive bounding boxes both of the primitive bounding boxes 242b, 244b will be determined to intersect the tile 222d and both the primitives 242a, 244a will accordingly be output to be processed to process the tile 222d.

Furthermore, in the present embodiment, the group bounding boxes 230, 240 are encoded relative to the packet bounding box 224 and the primitive bounding boxes 232b, 234b, 236b 242b, 244b are encoded relative to their group bounding box or another primitive bounding box within the same group bounding box. This can allow the bounding boxes to be stored for use in identifying what primitives and/or data is required for processing a tile, while requiring a smaller overall data size compared to if each bounding box was defined independently.

For example, by encoding the group bounding boxes 230, 240 relative to the packet bounding box 224 the smaller differences between the x and y ranges for each of the group bounding boxes 230, 240 and the packet bounding box 224 compared to between the x and y ranges for each of the group bounding boxes 230, 240 and the overall render output 220 size can be exploited to reduce the data size needed to encode the group bounding boxes 230, 240.

By encoding the primitive bounding boxes 232b, 234b, 236b, 242b, 244b relative to each other or to a group bounding box the data size needed to encode the primitive bounding boxes can also be reduced.

In particular, as two of the primitive bounding boxes 234b, 236b have the same values for all four components then one of these primitive bounding boxes can, for example, be efficiently encoded relative to the other by providing an indication of this instead of otherwise indicating the values for the components independently of other bounding boxes.

As one of the primitive bounding boxes 242b has the same values as its group bounding box 240b for all four components then the primitive bounding box 242b can, for example, be efficiently encoded relative to the group bounding box 240b by providing an indication of this instead of otherwise indicating the values for the components independently of other bounding boxes.

Other ones of the primitive bounding boxes can also be encoded relative to another primitive bounding box or a group bounding box to reduce the data size needed to store the bounding boxes compared to defining the bounding boxes independently.

Which bounding box is selected as a reference bounding box for a given primitive bounding box can be selected in any suitable manner, for example according to a selected encoding format, and may for example vary between bounding boxes associated with different primitives or different sub-sets of primitives.

A particular manner of encoding primitive bounding boxes within sets of commands, in accordance with an embodiment, is discussed further below.

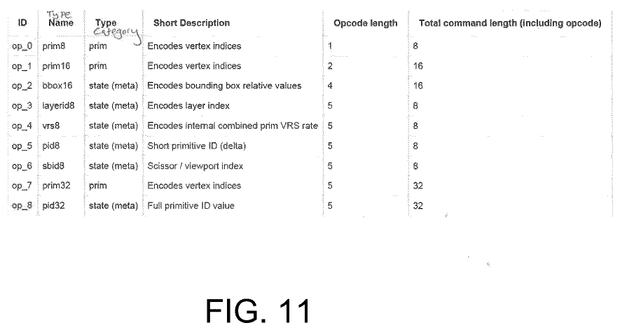

FIG. 11 shows by way of example, various different types of commands that may be used in a sequence of commands for a group of primitives according to an embodiment of the technology described herein.

Whilst FIG. 11 summarises a particular set of commands that are available to be used according to one command sequence format according to an embodiment of the technology described herein, it will be appreciated that there may be various other additional or alternative commands that can be included in a sequence of commands for a group of primitives (and correspondingly not all of the command types shown in FIG. 11 need to be used).

Thus, it will be understood that FIG. 11 is just showing one possible example of a command sequence format according to an embodiment of the technology described herein, but other sets of commands would of course be possible.

Each of the different types of commands in FIG. 11 is identifiable by a respective operating code (opcode) (as stored in the identifier (ID) field, shown in the furthest left hand side column of the table in FIG. 11).

The types of commands each fall into one of two categories. One of the categories is primitive commands (type category=“prim” in FIG. 11) that are commands for identifying individual primitives. Accordingly, at least one primitive command will be present for each primitive in the group of primitives that the sequence of commands is for. The other category is state commands (type category=“state (meta)” in FIG. 11) where each instance of a state command will encode data for all primitives in the sequence of commands up until the next instance of a state command of the same type in the sequence of commands. Accordingly, state commands may apply to individual primitives or to plural primitives.

The different types of commands will now be described, by way of example, for each of the two different categories of commands.

### 1. Primitive Commands

The primitive commands (type category=‘prim’ in FIG. 11) are dedicated for storing actual primitive data identifying the individual primitives that are included in a group of primitives. In particular, a primitive command stores a set of primitive vertex index values defining a respective primitive. The vertex index values are stored in a compressed form, as difference or delta values, as will be explained further below.

In the FIG. 11 example, there are three different primitive type commands, which differ primarily in terms of their size, i.e. how many bits are available for storing the vertex index (delta) values. In particular, in the present example, three types of primitive command are available, respectively ‘prim8’ (which is an 8-bit command), ‘prim16’ (a 16-bit command), and ‘prim32’ (a 32-bit command).

The respective formats for the three different primitive type commands that are used in this example are described below.

TABLE 1
prim8 command format

| Field | Width |
|---|---|
| ID | 1 |
| i0 | 3 |
| i1 | 2 |
| i2 | 2 |

In the prim8 type command (Table 1), the identifier field (ID) stores a respective opcode uniquely identifying that the command is a prim8 command. In this example the opcode for the prim8 type command (ID=op_0) uses a single bit (since ‘prim8’ commands are expected to be included relatively frequently, such that using a smaller opcode may be beneficial in terms of reducing the size of the ‘prim8’ command and hence the overall sequence of commands), but other arrangements would of course be possible.

The other fields in the prim8 command are then used to store delta compressed values for the primitive vertex indices. Thus, in this example, the primitive has three vertices, and the respective vertex index deltas are stored in three respective fields (i0, i1 and i2). (For other types of primitives, the available fields may be used, as desired, for storing any suitable and desired information that may be required for the primitive. For example, for points and lines, one of the fields (e.g. the index 2 field, i2) may be used to store the point size. Any such extra information that may be required for a primitive may be stored in any suitable format, e.g. compressed or not.)

In particular, the vertex index values for the primitive are stored in the respective fields by calculating the deltas (differences) between:
the current index 0 and the previous index 0 (for the first index value, which delta is stored in field i0—note that if there is no previous index 0 available, a default value is used that may, for example, be zero or may be encoded in the packet header);
the current index 1 and current index 0 (for the second index value, which delta is stored in field i1); and
current index 2 and current index 0 (for the third index value, which delta is stored in field i2).

When generating a sequence of commands, previous index values are therefore tracked for encoding subsequent index values, and separate index values may be tracked for primitives that undergo “early” (non-deferred) shading and for primitives that undergo deferred vertex shading respectively. In the non-deferred case, vertex indices are packet-local indices identifying particular vertices for which attributes are stored in the packet. In the deferred case, vertex indices are original indices stored in a vertex index buffer.

In the present embodiment, rather than storing the deltas in their ‘raw’ form, various offsets are applied to reduce the size of the deltas (to make them less positive). This then allows a greater range of positive values to be stored using fewer bits. For example, when storing the first index delta (index 0), a negative offset of two is applied to the delta, and the reduced delta value is then stored. This effectively increases the range of positive deltas that can be stored by two.

Furthermore, in the present embodiment, the second and third index deltas (index 1 and index 2) do not encode a zero value, as the indices within the same primitive should not be the same. Thus, when the second or third index delta is positive, a negative offset of one is applied to the delta (but no offset is applied when the delta is negative).

The primitive vertex index compression scheme thus works as set out below. This compression scheme determines the (reduced) delta values to be stored, and also determines the numbers of bits to encode each of the respective delta values.

Firstly, the delta index is calculated for the first index (index 0) compared to the previous index (last_index 0) in the sequence of commands. An offset of minus two is then applied to calculate the reduced value that is to be stored in field i0 using a 2's complement number format:

$$delta\_index 0 [ 31 : 0 ] = index 0 [ 31 : 0 ] - last\_index 0 [ 31 : 0 ] \#\# value wraps around \#\#$$

$$i 0 [ 31 : 0 ] = delta\_index 0 [ 31 : 0 ] - 2 \#\# value wraps around \#\#$$

The delta index values are then calculated for the second and third indices (index 1 and index 2) compared to the first index (index 0). As part of this, if the delta value is positive, an offset of minus one is applied.

delta_index1[31:0] = index1[31:0] − index0[31:0] ## value wraps
around ##
i1[31:0] = delta_index1[31:0]
if not (delta_index1[31]):
i1[31:0] = delta_index1[31:0] − 1 ## NEVER wraps around as delta
cannot be 0 ##
delta_index2[31:0] = index2[31:0] − index0[31:0] ## value wraps
around ##
i2[31:0] = delta_index2[31:0]
if not (delta_index2[31]):
i2[31:0] = delta_index2[31:0] − 1 ## NEVER wraps around as delta
cannot be 0 ##

The number of bits to encode each of the (reduced) delta values in the respective fields (i0, i1 and i2) is then calculated, as below. Note that in each case an additional bit is needed for storing the sign value. This information is used to select which of the primitive commands to store the primitive in, e.g. by selecting the appropriately sized primitive command (or set of primitive commands) based on the number of bits that are required to be stored.

if (i0[31]):
bits_to_encode_i0 = bits(abs(i0)−1) + 1
else:
bits_to_encode_i0 = bits(abs(i0)) + 1
if (i1[31]):
bits_to_encode_i1 = bits(abs(i1)−1) + 1
else:
bits_to_encode_i1 = bits(abs(i1)) + 1
if (i2[31]):
bits_to_encode_i2 = bits(abs(i2)−1) + 1
else:
bits_to_encode_i2 = bits(abs(i2)) + 1

The decompression performed when a primitive command is encountered then reverses the compression steps performed above. So, when decoding the first index delta (index 0), the negative two offset is reversed (i.e. by adding two to the value). Likewise, when decoding the second and third index deltas, if the stored values are positive (or zero), the negative one offset is reversed to recover the actual delta values. The reference (last, preceding) index is also sent and used with the decoded deltas to determine the full vertex indices.

The prim16 and prim32 command formats are set out below, and generally have a similar format to the prim8 command shown in Table 1, but with larger fields for storing larger vertex index deltas. The vertex index deltas are in an embodiment stored in the respective fields in the prim16 and prim32 commands in same manner described above for the prim8 command, using the same compression technique.

TABLE 2
prim16 command format

| Field | Width |
|---|---|
| ID | 2 |
| cont | 1 |
| i0 | 5 |
| i1 | 4 |
| i2 | 4 |

TABLE 3
prim32 command format

| Field | Width |
|---|---|
| ID | 5 |
| cont | 1 |
| i0 | 10 |
| i1 | 8 |
| i2 | 8 |

The prim16 and prim32 commands can thus be identified by their respective operating codes (opcodes), as indicated in the respective identifier (ID) field. In this example, the prim16 opcode (‘op_1’ in FIG. 11) is a 2-bit value, whereas the prim32 opcode (‘op_7’ in FIG. 11) is a 5-bit value. However, other arrangements would be possible.

As shown in Tables 2 and 3 above, the prim16 and prim32 commands also include an additional continuation bit (in the ‘cont’ field) the value of which indicates whether (or not) the encoding continues onto the next command. The purpose of this continuation bit is to allow select combinations of primitive commands to be used for storing data for a single primitive (e.g. where the vertex index deltas are too large to fit in a single prim8/prim16/prim32 command), as will be explained further below.

At least one of these primitive commands is therefore always required whenever a new primitive is to be included into the group of primitives. However, in the present example, a selection between the prim8/prim16/prim32 commands can be made based on the size of the index values that are to be encoded. Thus, if the delta index values for the primitive can fit inside a single prim8 command, the prim8 command is used. However, if the delta index values are too large to fit inside a prim8 command, a prim16 or prim32 command may instead be used.

As alluded to above, the present embodiment also allows combinations of two or more primitive commands to be used, in order to store larger delta values. In embodiments, in order to simplify the decoding logic, the possible combinations of primitive commands are restricted. Thus, in the present example, only certain combinations of primitive commands from all of the different possible combinations of primitive commands are permitted to be used. Any suitable combinations of primitive commands may be used. In an example, the combinations are restricted so that there can be only ever be one prim8 or prim16 command in a combination of commands, whereas multiple prim32 commands can be used. In that case, valid combinations of commands might include some of the examples given in Table 4 below.

There may also be a maximum number of commands that can be validly combined. For example, in an embodiment, up to four primitive commands may be combined to store data for a single primitive (in which case the maximum valid sequence of commands may be a combination of four prim32 commands, if that combination is permitted). However, the restricted set of combinations that can be validly used may be selected as desired in any suitable manner.

TABLE 4
Example combinations of primitive commands

| Commands (most significant bit | Available bits | Available bits |
|---|---|---|
| (MSB) to least significant bit (LSB)) | to encode i0 | to encode i1/i2 |
| prim8 | 3 | 2 |
| prim16 | 5 | 4 |
| prim8 prim16 | 8 | 6 |
| prim32 | 10 | 8 |
| prim8 prim32 | 13 | 10 |
| prim16 prim32 | 15 | 12 |
| prim32 prim32 | 20 | 16 |
| prim8 prim32 prim32 | 23 | 18 |
| prim16 prim32 prim32 | 25 | 20 |

The number and type of primitive commands that are included for a given primitive therefore depends on the required number of bits to encode each of the indices for the primitive, as calculated using the compression scheme above. Thus the appropriate command or combination of commands can be selected based on the calculated values bits_to_encode_i0, bits_to_encode_i1, bits_to_encode_i2, in order to fit the vertex index deltas into the command(s).

As mentioned above, where combinations of commands are used, the continuation bit (‘cont’) in the prim16/prim32 commands is then set accordingly to one, to indicate that there are more commands to encode for that primitive. The commands are sent starting from the least significant bit (LSB) index values. So, when a combination of prim8 and prim32 command are used, the prim32 command (storing the LSB index values) is in an embodiment sent first. This means in this example, where the available combinations are restricted such that only a single prim8 command is ever sent, the prim8 command does not need to store a continuation bit (and this is therefore not done). However, other arrangements would be possible.

By using the primitive commands described above, the present embodiment thus enables variable length encoding of the primitives using the different (combinations of the) available primitive commands.

It will be appreciated that this therefore allows for a more efficient approach for encoding the primitive data (the vertex indexes) as the amount of data used to store a primitive can be selected appropriately based on the size of the data.

It will also be appreciated from the above that the primitive commands store only the data actually identifying the individual primitives themselves, but do not in the present embodiment store any other, e.g. state, data describing the primitives, or how they should be processed. Such state type data is instead in the present embodiment stored using respective state commands, as will be described below. This helps simplify the primitive commands since they are dedicated for storing primitive data (the vertex index deltas).

### 2. State Commands

The state commands are used to encode primitive bounding boxes and metadata representing processing operations or parameters that should be used when rendering individual primitives. This data is therefore associated with the primitives and so may vary on a per-primitive basis. However, this data may also be shared between primitives, or at least may vary in a predicable manner, such that it does not always need to be encoded between primitives.

Thus, in the present embodiment, a number of dedicated state data command types are available that can be used to encode bounding boxes and the different types of state information at the appropriate positions within the sequence of commands. There are various examples of such state data, each having their own respective state-type command, as will be explained further below.

It will be appreciated that the use of dedicated state type commands simplifies the format of these commands, so that the respective state commands can be relatively small. For example, in the present embodiment, the state type commands are generally 8-bit commands, except for the bounding box command which is a 16-bit command, and the full primitive identifier command which is a 32-bit command but is only used when the primitive identifier cannot fit into the short (8-bit) primitive identifier command.

It will also be appreciated that the state type commands described below are merely some examples of possible state type commands and that other state type commands may be used, or different formats may be used to those set out below, depending on the types of state data that are desired to be encoded for the graphics processing system in question.

i) Bounding box (bbox16)

The bounding box command (bbox16) encodes a primitive bounding box. In addition to the opcode ID field, the bounding box contains four fields defining the minimum and maximum range of the bounding box in two dimensions (x and y) using four components (ymax, xmax, ymin, and xmin), where each of the components is encoded in a respective field.

In a bounding box command, each of the components for the bounding box is encoded as a delta from a previous value for that component, with the first bounding box command in the sequence of commands using a default value for the previous value, and subsequent bounding box commands using the value for that component in the previous bounding box command in the sequence of commands as the previous value.

The default values for the bounding box components can be predefined (such as zero for each of the components) or the default values can, for example, be set based on a group bounding box for the group of primitives that the sequence of commands in question is for.

When the default values are based on the group bounding box, a two-pass approach can be used during the encoding so that the first pass processes all of the primitives in the group to determine a group bounding box, and the second pass encodes the primitive bounding boxes using the group bounding box to set the default values to be used for encoding the first primitive bounding box.

The position represented by the encoded value for a bounding box component depends on the unit of processing during fragment shading, based for example on the size of a tile being processed. For example, a value of 1 could be used to represent the width of a tile (and smaller values representative of smaller distances). In the present embodiments, deltas for bounding box components are encoded in their respective fields within a bounding box command using a 2's complement number format (but this is not essential). If a bounding box command is not included for a primitive the previous primitive bounding box is used for the primitive.

TABLE 5
bounding box command format

| Field | Width |
|---|---|
| ID | 4 |
| xmin | 3 |
| ymin | 3 |
| xmax | 3 |
| ymax | 3 |

Other arrangements for bounding box commands would, of course, be possible. For example, when a two-pass approach is used during the encoding process where the first pass processes all of the primitives in the group to determine a group bounding box, the second pass may encode all of the primitive bounding boxes using deltas relative to the group bounding box, rather than deltas to the preceding primitive bounding box command.

### ii) Layer Index (Layerid8)

The layer index command (layerid8) encodes a layer index value, when this feature is enabled, to allow which layer of a plural different layers for a render output being generated a primitive should be processed for. The layer index value is encoded as a delta relative to a previous layer index value. If a layer index command is not included for a primitive and this feature is enabled, the previous value is used.

TABLE 6
layer index command format

| Field | Width |
|---|---|
| ID | 5 |
| Layer index | 3 |

iii) Variable Rate Shading (Vrs8)

The variable rate shading (VRS) command (vrs8) encodes a per-primitive VRS rate, where variable rate shading is enabled. The value encoded here is an internal representation of the output of a combiner circuit that indicates the VRS rate to be used. The variable rate shading command is thus only sent if variable rate shading is enabled, and the rate changes compared with the previous primitive. The value that is sent is the new VRS rate.

TABLE 7
variable rate shading command format

| Field | Width |
|---|---|
| ID | 5 |
| vrs_int_rate | 3 |

### iv) Scissor Index (Sbid8)

The scissor index (sbid8) command relates to a scissor index, which is used to determine whether and/or how a scissor operation is to be performed for the primitive. The scissor index is only sent if scissor arrays are enabled and the number of scissors is more than one. If the scissor index command is not sent, the previous value is used. The value defaults to zero for each draw call.

TABLE 8
scissor index command format

| Field | Width |
|---|---|
| ID | 5 |
| sbid | 3 |

### v) Short Primitive Id (Pid8)

The short primitive identifier (pid8) command is an 8-bit command that encodes the delta value of the primitive ID (pid) as compared with the previous primitive in the group (or a default value, in the case of the first primitive in the group). When primitive ID is enabled, primitive ID is incremented by one by default if this command (or the pid32 command) is not included.

When primitive ID is enabled and the next primitive in a group of primitives being encoded has a primitive ID one higher than the previous primitive, a primitive identifier (pid8/pid32) command may therefore not be included for the next primitive (and the primitive ID for the next primitive can be determined when decoding the group of primitives by incrementing the primitive ID of the previous primitive by one).

In an embodiment, a primitive identifier (pid8/pid32) command may always be encoded for the first primitive with a non-zero primitive ID value following a previous primitive ID value of zero (such as a default value of zero). This may, for example, indicate to a decoder the start of the incrementing of primitive IDs when a primitive identifier (prim8/prim32) command is not included for subsequent primitives.

In another embodiment, the decoder may start the incrementing of primitive IDs at the start of the primitive group, so that for example when a default primitive ID=0 and the first primitive in the group has primitive ID=1, a primitive identifier (pid8/pid32) command is not included for the first primitive in the group and the primitive ID is decoded by incrementing the value of zero by one.

TABLE 9
short primitive id command format

| Field | Width |
|---|---|
| ID | 5 |
| pid | 3 |

### vi) Full Primitive Id (Pid32)

The full primitive identifier (pid32) command is a 32-bit command that encodes the full absolute value of the primitive ID. The full primitive identifier (‘pid32’) command can thus be used when the last value of primitive ID is not known, or the delta value does not fit in a short primitive identifier (‘pid8’) command. The value that is sent is the current absolute primitive ID value.

TABLE 10
full primitive id command format

| Field | Width |
|---|---|
| ID | 5 |
| cont | 1 |
| pid | 26 |

Again, it will be appreciated that these are merely some examples of types of state data commands that may be included into a sequence of commands according to the present embodiment. Other examples of state type commands that may or may not be used would of course be possible depending on the features and modes of the graphics processing system in question and which state data may therefore be desired to be indicated.

As described further below, a sequence of commands for a group of primitives can be generated using a number of commands of the command types shown in FIG. 11.

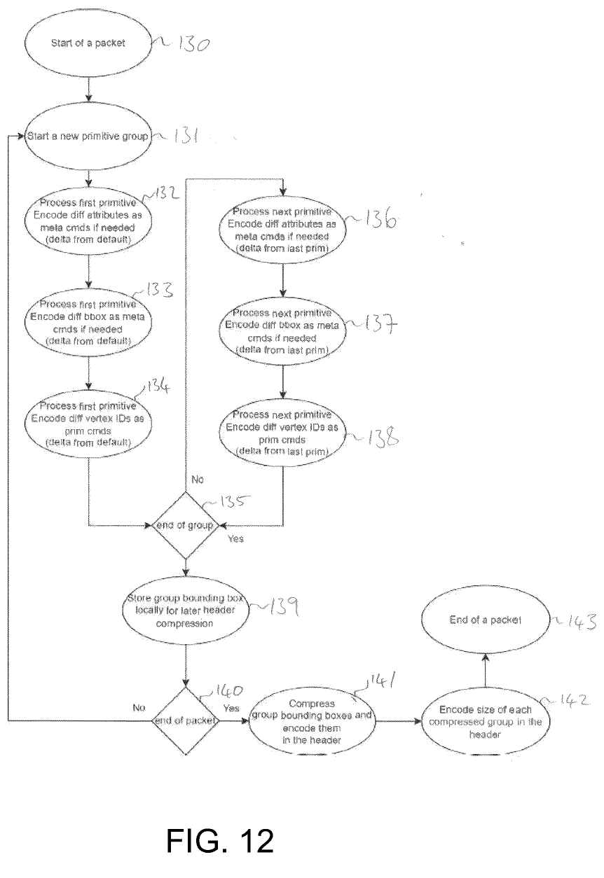

FIG. 12 shows an encoding operation that encodes a packet by generating sequences of commands representing respective groups of primitives within the packet.

As shown in FIG. 12, when a packet is to be encoded (step 130), a new primitive group is begun (step 131) for which a sequence of commands is generated. To generate a sequence of commands for a primitive group, data for a first primitive to be encoded in the group is read and a set of commands encoding data to be used when processing the first primitive are generated. Generating the set of commands for the first primitive comprises generating any required state commands (step 132) encoding state data for processing the primitive, generating one or more primitive bounding box commands that encodes a bounding box for the primitive (step 133) (unless the primitive has the same primitive bounding box as the previous primitive, in which case in the present embodiments a bounding box command is not required for the primitive), and generating one or more primitive commands (step 134) that encode vertex indices for identifying the vertices that define the primitive. As explained above, state commands generated for the first primitive may also be applicable to one or more other subsequent primitives in the group, whereas primitive commands generated for the first primitive are applicable only to the first primitive. In the present embodiments, the bounding box commands are a specific type of state command that, together with other state commands, may also be applicable one or more other primitives.

When the set of commands for the first primitive in the group have been generated, it is determined whether another primitive should be added to the same primitive group (step 135). This can be determined in any suitable manner, for example based on a number of primitives remaining to be encoded in the packet and/or a set maximum number of primitives to be included in each primitive group.

When it is determined that another primitive should be added to the same primitive group (and thus it is determined that the group has not reached its end), a set of commands for a second primitive in the group are generated and added to the sequence of commands for the primitive group. Generating a set of commands for the second primitive in the group may comprise generating one or more state commands (step 136) encoding state data for processing the second primitive, and/or generating one or more primitive bounding box commands (step 137) for the second primitive. However, when the second primitive has a same state data value (or bounding box) that has been encoded by a command included for the first primitive (and so a same type of command has been included for the first primitive that encodes the same value applying to the second primitive), a command for that state data (or for the bounding box) is not included for the second primitive and instead, when the sequence of commands is read, the value for the state data (or for the bounding box) provided for the first primitive is also applied to the second primitive in the absence of any new command of the same type. As with the first primitive, generating a set of commands for the second primitive in the group also comprises generating one or more primitive commands (step 138) that encode vertex indices for identifying vertices that define the second primitive.

Furthermore, in the present embodiments, when a primitive bounding box command is included for the second primitive or for any subsequent primitive in the same group, the primitive bounding box command encodes a primitive bounding box relative to another (reference) bounding box, such as a primitive bounding box for a previous primitive in the group. Other commands included for the second primitive can also encode data for the second primitive relative to the first primitive, where, for example, a vertex index for the second primitive is provided as a difference (a delta) compared to the vertex index for the first primitive (and as described above, deltas can also be used for other values encoded by the commands).

When the set of commands for the second primitive in the group have been generated, it is again determined whether another primitive should be added to the same primitive group, and steps 136, 137, 138 and 135 can be repeated for the next primitive to add a set of commands for the next primitive to the sequence of commands for the primitive group, and so on, until it is determined that no further primitives should be included in the primitive group (and thus the primitive group is ended).

As described above, in the generated sequence of commands for the primitive group, a command for a primitive in the group can encode data for the primitive relative to the previous instance of the same type of command included in the sequence of commands. When there is no previous instance of that type of command in the sequence of commands, the command encodes the data using a delta relative to default value(s).

When a primitive group is ended and the sequence of commands for the primitive group have been generated, a bounding box for the primitive group is generated and stored locally for later encoding (step 139). It is then determined whether the end of the packet has been reached (step 140), or whether any further primitives should be added to the packet in additional groups. When an additional primitive group is to be included in the packet, steps 130-139 can be repeated to generate a sequence of commands and group bounding for the next primitive group to be included in the packet as appropriate, until there are no further primitive groups to add to the packet.

When all of the primitive groups have been generated, the bounding boxes stored locally for the groups of primitives are then encoded in the header for the packet (step 141). An indication of where the sequence of commands for respective ones of the primitive groups is stored within the packet is also encoded in the header (142). In the present embodiments this comprises encoding a data size for each of the primitive groups. The header accordingly allows the bounding box for a primitive group to be usable to identify the sequence of commands for primitives in the group. When the header has finished being encoded, the encoding of the packet is then completed (step 143).

FIG. 12 shows a single pass encoding operation. However, as described above, other approaches would be possible, such as using a two pass approach.

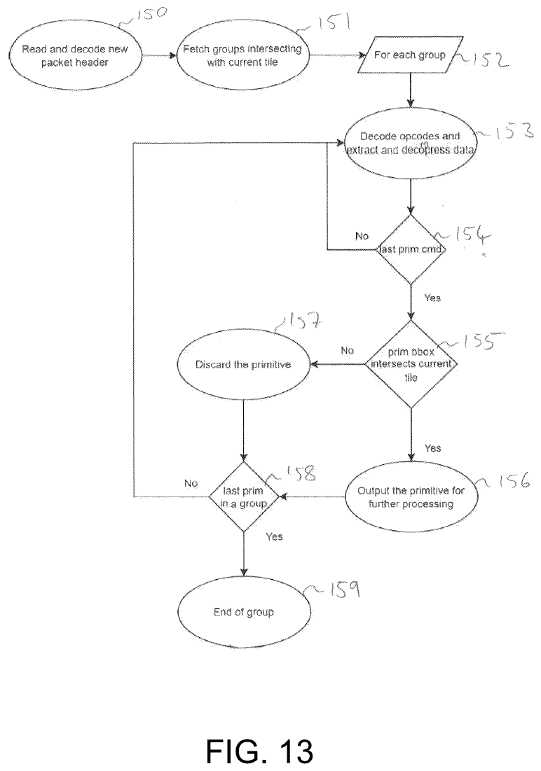

FIG. 13 shows an exemplary decoding operation used to identify primitives in a packet that are to be processed for a tile being processed by a shader core 32.

As shown in FIG. 13, to decode a packet the header of the packet is read and decoded (step 150), data from the header is used to identify a group or groups of primitives that should be processed for the tile being processed by the shader core, and data for the identified group(s) are then also read from the packet (step 151). To identify group(s) of primitives that should be processed for the tile being processed by the shader core, bounding boxes stored in the header for respective groups of primitives are tested to identify the bounding box or boxes that intersect with the tile being processed, and the group(s) that should be processed for the tile are identified based on whether or not the bounding box for a group of primitives intersects with the tile being processed.

For each group of primitives identified (step 152), a sequence of commands for the group is decoded from the packet (step 153). The sequence of commands is read to determine the commands in the sequence that are applicable to each of the primitives in the group that the sequence of commands is for (step 154). When the required commands for a primitive in the group have been read, it is determined whether a bounding box for the primitive in question intersects with the tile being processed by the shader core (step 155).

When it is determined that a bounding box for a primitive does intersect the tile being processed, the primitive is output for further processing (step 156). Whereas when it is determined that a bounding box for a primitive does not intersect the tile being processed, the primitive is discarded (step 157). When the commands for a primitive have finished being read, and the primitive is either output or discarded, it is determined whether there are commands for any remaining primitives in the group (step 158) and, when there are any remaining primitives, the commands for the next primitive are read from the sequence of commands and steps 154-158 are repeated for the next primitive. This process is carried out for all remaining primitives in the group until it is determined that there are no commands remaining to be read from the sequence of commands for the primitives in the group, at which point the reading of the sequence of commands for that group is completed (step 159).

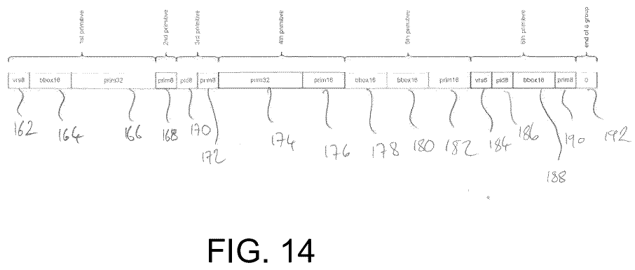

FIG. 14 shows an example of a sequence of commands for a group of primitives in a packet, in accordance with an embodiment of the technology described herein.

The sequence of commands shown in FIG. 14 is for a group of six primitives. However, any other number of primitives may be included in a group.

The sequence of commands uses commands of the types described above. However, it would of course be possible to use other types of commands.

The encoding of the commands for each primitive in the group will now be described for each primitive in turn, with reference to examples of sets of input data for the primitives to be encoded within the sequence of commands.

### First Primitive

The first primitive in the group uses commands defined according to a set of default values for the input parameters.

The default values are:

$$VRS rate = 1 \times 1$$

$$Primitive ID = 0 \times 0$$

$$Primitive bounding box = ( 0 \times 0 , 0 \times 0 , 0 \times 0 , 0 \times 0 )$$

$$i 0 vertex ID = 0 \times 0$$

The first primitive has input parameters with the following values:

$$VRS rate = 4 \times 4$$

$$Primitive ID = 0 \times 1$$

$$Primitive bounding box = ( 0 \times 1 , 0 \times 1 , 0 \times 3 , 0 \times 2 )$$

$$Vertex IDs ( i 0 , i 1 , i 2 ) = ( 0 \times 15 D , 0 \times 15 F , 0 \times 160 )$$

As the VRS rate for the first primitive is different to the default value, the first command (162) is a vrs8 command that indicates the VRS rate for the first primitive using the value:

$$vrs\_int \_rate = 4 \times 4.$$

As the primitive ID for the first primitive is one greater than the default value, no command is needed to encode the primitive ID for the first primitive (the primitive ID is incremented by one if neither a pid8 or pid32 command is present).

As the bounding box for the first primitive has values different to the default values, the second command (164) is a bbox16 command that indicates the bounding box for the first primitive using the following delta values defined relative to the default values:

$$( delta\_xmin , delta\_ymin , delta\_xmax , delta\_ymax ) = ( 0 \times 1 - 0 \times 0 , 0 \times 1 - 0 \times 0 , 0 \times 3 - 0 \times 0 , 0 \times 2 - 0 \times 0 ) = ( 0 \times 1 , 0 \times 1 , 0 \times 3 , 0 \times 2 )$$

The vertex IDs for the first primitive are indicated with the following offset delta values, where offset_delta_i0 is defined relative to the default i0 value, and offset_delta_i1 and offset_delta_i2 are defined relative to the i0 value for the first primitive:

$$( offset\_delta \_i 0 , offset\_delta \_i 1 , offset\_delta \_i 2 ) = ( 0 \times 15 D - 0 \times 0 , 0 \times 15 F - 0 \times 15 D \{ - 1 as > 0 \} , 0 \times 160 - 0 \times 15 D \{ - 1 as > 0 \} ) = ( 0 \times 15 B , 0 \times 1 , 0 \times 2 )$$

Based on the numbers of bits needed to encode these values, a prim32 command is selected to encode the vertex IDs as the third command (166) for the first primitive.

Accordingly, the parameter values for the first primitive are encoded by including the following three commands (162, 164, 166) in the sequence of commands:

$$vrs 8 ( vrs\_int \_rate = 4 \times 4 ) ;$$

$$bbox 16 ( x min = 0 \times 1 , y min = 0 \times 1 , x max = 0 \times 3 , y max = 0 \times 2 ) ;$$

$$prim 32 ( cont = 0 , i 0 = 0 \times 15 B , i 1 = 0 \times 1 , i 2 = 0 \times 2 )$$

### Second Primitive

The second primitive has input parameters with the following values:

$$VRS rate = 4 \times 4$$

$$Primitive ID = 0 \times 2$$

$$Primitive bounding box = ( 0 \times 1 , 0 \times 1 , 0 \times 3 , 0 \times 2 )$$

$$Vertex IDs ( i 0 , i 1 , i 2 ) = ( 0 \times 15 E , 0 \times 15 C , 0 \times 15 F )$$

As the VRS rate for the second primitive is the same as for the first primitive, no command is needed to indicate the VRS rate for the second primitive.

As the primitive ID for the second primitive is one greater than the primitive ID for the first primitive, no command is needed to indicate the primitive ID for the second primitive.

As the primitive bounding box for the second primitive is the same as for the first primitive, no command is needed to indicate the primitive bounding box for the second primitive.

The vertex IDs for the second primitive are indicated with the following offset delta values, where offset_delta_i0 is defined relative to the i0 value for the first primitive, and offset_delta_i1 and offset_delta_i2 are defined relative to the i0 value for the second primitive:

$$( offset\_delta \_i 0 , offset\_delta \_i 1 , offset\_delta \_i 2 ) = ( 0 \times 15 E - 0 \times 15 D - 2 , 0 \times 15 C - 0 \times 15 E , 0 \times 15 F - 0 \times 15 E \{ - 1 as > 0 \} ) = ( 0 \times 7 , 0 \times 2 , 0 \times 0 )$$

Where 0x7 is used to denote an offset delta value of −1 (using a 2's complement number format with 3 bits) for i0, and 0x2 is used to denote an offset delta value of −2 (using a 2's complement number format with 2 bits) for i1.

Based on the numbers of bits needed to encode these values, a prim8 command is selected to encode the vertex IDs as the single command (168) for the second primitive:

$$prim 8 ( i 0 = 0 \times 7 , i 1 = 0 \times 2 , i 2 = 0 \times 0 )$$

### Third Primitive

The third primitive has input parameters with the following values:

$$VRS rate = 4 \times 4$$

$$Primitive ID = 0 \times 4$$

$$Primitive bounding box = ( 0 \times 1 , 0 \times 1 , 0 \times 3 , 0 \times 2 )$$

$$Vertex IDs ( i 0 , i 1 , i 2 ) = ( 0 \times 161 , 0 \times 162 , 0 \times 163 )$$

As the VRS rate for the third primitive is the same as for the second primitive, no command is needed to indicate the VRS rate for the third primitive.

As the primitive ID for the third primitive is two greater than the primitive ID for the second primitive (and therefore other than one greater than for the preceding primitive), a pid8 command is used as the first command (170) for the third primitive to indicate the primitive ID as a delta value relative to the second primitive:

$$delta\_primitiveID = 0 \times 4 - 0 \times 2 = 0 \times 2$$

As the primitive bounding box for the third primitive is the same as for the second primitive, no command is needed to indicate the primitive bounding box for the third primitive.

The vertex IDs for the third primitive are indicated with the following offset delta values, where offset_delta_i0 is defined relative to the i0 value for the second primitive, and offset_delta_i1 and offset_delta_i2 are defined relative to the i0 value for the third primitive:

$$( offset\_delta \_i 0 , offset\_delta \_i 1 , offset\_delta \_i 2 ) = ( 0 \times 161 - 0 \times 15 E - 2 , 0 \times 162 - 0 \times 161 \{ - 1 as > 0 \} , 0 \times 163 - 0 \times 161 \{ - 1 as > 0 \} ) = ( 0 \times 1 , 0 \times 0 , 0 \times 1 )$$

Based on the numbers of bits needed to encode these values, a prim8 command is selected to encode the vertex IDs as the second command (172) for the third primitive, such that the two commands (170, 172) for the third primitive are:

$$pid 8 ( pid = 0 \times 2 ) ;$$

$$prim 8 ( i 0 = 0 \times 1 , i 1 = 0 \times 0 , i 2 = 0 \times 1 )$$

### Fourth Primitive

The fourth primitive has input parameters with the following values:

$$VRS rate = 4 \times 4$$

$$Primitive ID = 0 \times 5$$

$$Primitive bounding box = ( 0 \times 1 , 0 \times 1 , 0 \times 3 , 0 \times 2 )$$

$$Vertex IDs ( i 0 , i 1 , i 2 ) = ( 0 \times 1 F 63 , 0 \times 1 F 65 , 0 \times 1 F 61 )$$

As the VRS rate for the fourth primitive is the same as for the third primitive, no command is needed to indicate the VRS rate for the fourth primitive.

As the primitive ID for the fourth primitive is one greater than the primitive ID for the third primitive, no command is needed to indicate the primitive ID for the fourth primitive.

As the primitive bounding box for the fourth primitive is the same as for the third primitive, no command is needed to indicate the primitive bounding box for the third primitive.

The vertex IDs for the fourth primitive are indicated with the following offset delta values, where offset_delta_i0 is defined relative to the i0 value for the second primitive, and offset_delta_i1 and offset_delta_i2 are defined relative to the i0 value for the third primitive:

$$( offset\_delta \_i0 , offset\_delta \_i1 , offset\_delta \_i2 ) = ( 0 \times 1 F 63 - 0 \times 1 \; 61 - 2 , 0 \times 1 F 65 - 0 \times 1 F 63 \{ - 1 as > 0 \} , 0 \times 1 F 61 - 0 \times 1 F 63 ) = ( 0 \times 1 E 00 , 0 \times 1 , 0 \times 2 )$$

Where 0x2 is used to denote an offset delta value of −2 (using a 2's complement number format with 2 bits) for i2.

Based on the numbers of bits needed to encode these values, a prim32 in combination with a prim16 command is selected to encode the vertex IDs as the first (174) and second (176) commands for the fourth primitive:

$$prim 32 ( cont = 1 , i 0 = 0 \times 200 , i 1 = 0 \times 1 , i 2 = 0 \times FE ) ;$$

$$prim 16 ( cont = 0 , i 0 = 0 \times 7 , i 1 = 0 \times 0 , i 2 = 0 \times F )$$

Where for i0, the prim32 command encodes the bottom 10 bits and the prim16 command encodes the top 5 bits (0x1E00=7680=001 1110 0000 0000=0 0111:10 0000 0000=0x7: 0x200). For i1, the prim32 command encodes the bottom 8 bits and the prim16 command encodes the top 4 bits (0x1=1=0000 0000 0001=0000:0000 0001=0x0: 0x1). For i2, the prim32 command encodes the bottom 8 bits and the prim16 command encodes the top 4 bits (0x2=−2=1111 1111 1110=1111: 1111 1110=0xF: 0xFE).

### Fifth Primitive

The fifth primitive has input parameters with the following values:
VRS rate=4x4

$$Primitive ID = 0 \times 6$$

$$Primitive bounding box = ( 0 \times 0 , 0 \times 0 , 0 \times 17 , 0 \times 17 )$$

$$Vertex IDs ( i 0 , i 1 , i 2 ) = ( 0 \times 1 F 55 , 0 \times 1 F 56 , 0 \times 1 F 57 )$$

As the VRS rate for the fifth primitive is the same as for the fourth primitive, no command is needed to indicate the VRS rate for the fifth primitive.

As the primitive ID for the fifth primitive is one greater than the primitive ID for the fourth primitive, no command is needed to indicate the primitive ID for the fifth primitive.

The values for the primitive bounding box for the fifth primitive are different to those for the primitive bounding box for the fourth primitive. The delta values for the primitive bounding box for the fifth primitive defined relative to the values for the fourth primitive are:

$$( delta\_xmin , delta\_ymin , delta\_xmax , delta\_ymax ) = ( 0 \times 0 - 0 \times 1 , 0 \times 0 - 0 \times 1 , 0 \times 17 - 0 \times 3 , 0 \times 17 - 0 \times 2 ) = ( 0 \times 7 , 0 \times 7 , 0 \times 14 , 0 \times 15 )$$

Due to the number of bits needed to encode these values, two bbox16 commands are included as the first (178) and second (180) commands for the fifth primitive, where the two bbox16 commands together encode the bounding box values for the fifth primitive:

$$bbox 16 ( xmin = 0 \times 7 , ymin = 0 \times 7 , xmax = 0 \times 4 , ymax = 0 \times 5 ) ;$$

$$bbox 16 ( xmin = 0 \times 7 , ymin = 0 \times 7 , xmax = 0 \times 2 , ymax = 0 \times 2 )$$

Where the offset delta values for xmin and ymin are −1, which is represented by 0x7=111 using a 2's complement number format with 3 bits, but is sign extended to be represented by 0x3F=11 1111 when using a 2's complement number format with 6 bits, which is split into 111:111=0x7: 0x7 across the two bbox16 commands. The offset delta value for xmax is 20, which is represented by 0x14=01 0100 with 6 bits and is split into 010:100=0x2: 0x4 across the two bbox16 commands. The offset delta value for ymax is 21, which is represented by 0x15=01 0101 with 6 bits and is split into 010:101=0x2: 0x5 across the two bbox16 commands.

The vertex IDs for the fifth primitive are indicated with the following offset delta values, where offset_delta i0 is defined relative to the i0 value for the fourth primitive, and offset_delta_i1 and offset_delta_i2 are defined relative to the i0 value for the fifth primitive:

$$( offset\_delta \_i0 , offset\_delta \_i1 , offset\_delta \_i2 ) = ( 0 \times 1 F 55 - 0 \times 1 F 63 - 2 , 0 \times 1 F 56 - 0 \times 1 F 55 \{ - 1 as > 0 \} , 0 \times 1 F 57 - 0 \times 1 F 55 \{ - 1 as > 0 \} ) = ( 0 \times 10 , 0 \times 0 , 0 \times 1 )$$

Based on the numbers of bits needed to encode these values, a prim16 command is selected to encode the vertex IDs as the third command (182) for the fifth primitive, such that the three commands (180, 180, 182) for the fifth primitive are:

$$bbox 16 ( xmin = 0 \times 7 , ymin = 0 \times 7 , xmax = 0 \times 4 , ymax = 0 \times 5 ) ;$$

$$bbox 16 ( xmin = 0 \times 7 , ymin = 0 \times 7 , xmax = 0 \times 2 , ymax = 0 \times 2 ) ;$$

$$prim 16 ( cont = 0 , i 0 = 0 \times 10 , i 1 = 0 \times 0 , i 2 = 0 \times 1 )$$

### Sixth Primitive

The sixth primitive has input parameters with the following values:

$$VRS rate = 1 \times 1$$

$$Primitive ID = 0 \times 8$$

$$Primitive bounding box = ( 0 \times 1 , 0 \times 1 , 0 \times 18 , 0 \times 18 )$$

$$Vertex IDs ( i 0 , i 1 , i 2 ) = ( 0 \times 1 F57 , 0 \times 1 F 58 , 0 \times 1 F59 )$$

As the VRS rate is different for the sixth primitive compared to the fifth primitive, a vrs8 command is included as the first command (184) for the sixth primitive that indicates the VRS rate for the sixth primitive using the value:

$$vrs\_int \_rate = 1 \times 1.$$

As the primitive ID for the sixth primitive is two greater than the primitive ID for the fifth primitive (and therefore other than one greater than for the preceding primitive), a pid8 command is included as the second command (186) for the sixth primitive to indicate the primitive ID as a delta value relative to the fifth primitive:

$$delta\_primitiveID = 0 \times 8 - 0 \times 6 = 0 \times 2$$

The values for the primitive bounding box for the sixth primitive are different to those for primitive bounding box for the fifth primitive. The delta values for the primitive bounding box for the sixth primitive defined relative to the values for the fifth primitive are:

$$( delta\_xmin , delta\_ymin , delta\_xmax , delta\_ymax ) = ( 0 \times 1 - 0 \times 0 , 0 \times 1 - 0 \times 0 , 0 \times 18 - 0 \times 17 , 0 \times 18 - 0 \times 17 ) = ( 0 \times 1 , 0 \times 1 , 0 \times 1 , 0 \times 1 )$$

These values are indicated using a single bbox16 command as the third command (188) for the sixth primitive.

The vertex IDs for the sixth primitive are indicated with the following offset delta values, where offset_delta_i0 is defined relative to the i0 value for the fifth primitive, and offset_delta i1 and offset_delta i2 are defined relative to the i0 value for the sixth primitive:

$$( offset\_delta \_i0 , offset\_delta \_i1 , offset\_delta \_i2 ) = ( 0 \times 1 F 57 - 0 \times 1 F 55 - 2 , 0 \times 1 F 58 - 0 \times 1 F 57 \{ - 1 as > 0 \} , 0 \times 1 F 59 - 0 \times 1 F 57 \{ - 1 as > 0 \} ) = ( 0 \times 0 , 0 \times 0 , 0 \times 1 )$$

Based on the numbers of bits needed to encode these values, a prim8 command is selected to encode the vertex IDs as the fourth command (190) for the sixth primitive, such that the four commands (184, 186, 188, 190) for the sixth primitive are:

$$vrs 8 ( vrs\_int \_rate = 1 \times 1 )$$

$$pid 8 ( pid = 0 \times 2 )$$

$$bbox 16 ( xmin = 0 \times 1 , ymin = 0 \times 1 , xmax = 0 \times 1 , ymax = 0 \times 1 ) ;$$

$$prim 8 ( i 0 = 0 \times 0 , i 1 = 0 \times 0 , i 2 = 0 \times 1 )$$

There are no further primitives to be encoded in the sequence of commands, and therefore the sequence of commands is ended by including an “end of group” command (192) in the sequence of commands after the commands for the sixth primitive. The end of group command can take any suitable form, such as being provided in the form of another type of command but with particular values to indicate that it is an end of group command. For example, the end of group command can be provided as a prim8 command indicating at least two matching vertex indices, such as indicating that all the vertex indices have a value of zero, which could be recognised as being an end of group command instead of a command for a subsequent primitive on the basis that a primitive should not have plural vertices with the same index.

Other ways of indicating the end of a sequence of commands for a group of primitives are, of course, possible, such as based on the sequence of commands reaching a maximum limit of primitives being included.

Although embodiments of the technology described herein have been described relating to bounding boxes being provided for packets, groups of primitives and individual primitives, the technology described herein is also applicable more generally to at least two levels of a bounding box hierarchy being provided, for example where packets store bounding boxes for individual primitives but not groups of primitives, or for example where bounding boxes for groups of primitives are the lowest level of the hierarchy and data for all of the primitives in a group of primitives is output when it is identified that the group of primitives should be processed.

It can be seen from the above that the technology described herein, in its embodiments at least, can provide a manner of storing/reading primitive data which can allow a render output to be processed more efficiently (e.g. in terms of lower latencies, less data bandwidth requirement, higher throughput, lower energy consumption). This is achieved, in the embodiments of the technology described herein at least, by storing in a packet data to be used for processing primitives in a hierarchical manner where at least some of the levels of the hierarchy correspond to levels in a hierarchy of bounding boxes for identifying which primitives should be processed for respective regions of a render output. Storing data in this manner can allow the data needed to process primitives for a particular region of a render output to be identified and read more efficiently compared to relying on more serialised data structures for storing primitive data.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a graphics processing system when performing tile-based rendering, in which a render output is divided into a plurality of tiles for rendering purposes, the method comprising:
generating a packet comprising primitives to be processed for a render output; and
generating bounding boxes that can be used to identify primitives in the packet to be processed for a respective region of the render output;
wherein the packet comprises:
a set of higher level data to be used to process a set of primitives, wherein the set of primitives is identifiable from the packet, and wherein a bounding box associated with the set of primitives is usable to identify whether the set of primitives should be processed for a respective region of a render output; and
sets of lower level data to be used to process sub-sets of one or more primitives in the set of primitives that the higher level data is for, wherein which respective set of lower level data is for which respective sub-set of one or more primitives is identifiable from the packet, and wherein bounding boxes associated with the sub-sets of one or more primitives are usable to identify whether the sub-sets of one or more primitives should be processed for a respective region of a render output;
such that when the bounding boxes identify that a sub-set of one or more primitives should be processed for a respective region of a render output, the set of higher level data and the set of lower level data to be used for processing the sub-set of one or more primitives is identifiable from the packet.

2. The method of claim 1, wherein the set of primitives that the set of higher level data is to be used to process comprises all of the primitives in the packet.

3. The method of claim 1, wherein the set of higher level data comprises configuration data for a draw call that the set of primitives in the packet is for.

4. The method of claim 1, wherein the set of higher level data comprises a pointer to data stored separately to the packet, and wherein the data stored separately to the packet is usable for processing the set of primitives in the packet and is usable for processing primitives in at least one other packet.

5. The method of claim 1, wherein a set of lower level data for a sub-set of one or more primitives identifies one or more of:
the primitive or primitives within the sub-set of one or more primitives; and
processing operations or parameters that should be used when processing the primitive or respective ones of primitives within the sub-set of one or more primitives.

6. The method of claim 1, wherein a sub-set of one or more primitives in the set of primitives comprises a group of plural primitives in the set of primitives; and
the set of lower level data for the sub-set comprising a group of plural primitives comprises a set of commands to be used to process the group of plural primitives, the set of commands comprising:
one or more commands that each identify a processing operation or parameter that should be used when processing an individual primitive in the group of plural primitives; and
one or more commands that each identify a processing operation or parameter that should be used when processing plural ones of the primitives in the group of plural primitives.

7. The method of claim 1, wherein a sub-set of one or more primitives in the set of primitives comprises a group of plural primitives in the set of primitives; and
the set of lower level data for the sub-set comprising a group of plural primitives in the set of primitives encodes data for one or more primitives in the group of plural primitives relative to data for at least one other primitive in the group of plural primitives.

8. The method of claim 1, wherein the sets of lower level data are decodable independently of one another.

9. A method of operating a graphics processor when performing tile-based rendering, in which a render output is divided into a plurality of tiles for rendering purposes, and in which packets are provided comprising respective sets of primitives to be processed for a render output, the method comprising:
using bounding boxes associated with packets for a render output to identify whether any of the packets should be read for a respective region of the render output; and
when it is identified that a packet should be read for the region of the render output:
reading from the packet a set of higher level data for processing a set of primitives in the packet;
using bounding boxes associated with sub-sets of one or more primitives in the set of primitives to identify whether any of the sub-sets of one or more primitives should be processed for the region of the render output; and
for each sub-set of one or more primitives that it is identified should be processed for the region of the render output:
reading from the packet a set of lower level data for processing the primitive or primitives in the sub-set of one or more primitives; and
processing a primitive or primitives in the sub-set of one or more primitives using the set of higher level data and the set of lower level data.

10. The method of claim 9, comprising:
for a sub-set of primitives comprising a group of plural primitives that it is identified should be processed for a region of a render output:
reading from the packet a set of lower level data for processing primitives in the group of plural primitives;
identifying whether any of the primitives in the group of plural primitives should be processed for the region of the render output; and
when it is identified that one or more primitives in the group of plural primitives should be processed for the region of the render output:
processing the one or more primitives in the group of plural primitives that it is identified should be processed for the region of the render output using the set of lower level data for the sub-set of primitives and the set of higher level data for the set of primitives comprising the sub-set of primitives.

11. The method of claim 9, wherein reading a set of lower level data from a packet comprises decoding a set of commands for the set of lower level data; and
decoding the set of commands for the set of lower level data comprises decoding a command in the set of commands that is encoded relative to one or more other commands in the set of commands.

12. The method of claim 9, comprising, when it is identified that plural sub-sets of one or more primitives should be processed for a region of a render output, decoding sets of lower level data for different ones of the plural sub-sets of primitives in parallel with one another.

13. A graphics processor operable to perform tile-based rendering, in which a render output is divided into a plurality of tiles for rendering purposes, the graphics processor comprising:
a packet generating circuit configured to generate packets comprising primitives to be processed for a render output;
a bounding box generating circuit configured to generate bounding boxes that can be used to identify primitives in a packet to be processed for respective regions of a render output; and
a packet processing circuit configured to generate and store in a packet:
a set of higher level data to be used to process a set of primitives, wherein the set of primitives that the higher level data is to be used to process is identifiable from the packet, and wherein a bounding box associated with the set of primitives is usable to identify whether the set of primitives should be processed for a respective region of a render output; and
sets of lower level data to be used to process sub-sets of one or more primitives in the set of primitives that the higher level data is for, wherein which respective set of lower level data is for which respective sub-set of one or more primitives is identifiable from the packet, and wherein bounding boxes associated with the sub-sets of one or more primitives are usable to identify whether the sub-sets of one or more primitives should be processed for a respective region of a render output;
such that when the bounding boxes identify that a sub-set of one or more primitives should be processed for a respective region of a render output, the set of higher level data and the set of lower level data to be used for processing the sub-set of one or more primitives is identifiable from the packet.

14. The graphics processor of claim 13, wherein the set of higher level data comprises configuration data for a draw call that the set of primitives in the packet is for.

15. The graphics processor of claim 13, wherein the set of higher level data comprises a pointer to data stored separately to the packet, and wherein the data stored separately to the packet is usable for processing the set of primitives in the packet and is usable for processing primitives in at least one other packet.

16. The graphics processor of claim 13, wherein a set of lower level data for a sub-set of one or more primitives identifies one or more of:
the primitive or primitives within the sub-set of one or more primitives; and
processing operations or parameters that should be used when processing the primitive or respective ones of primitives within the sub-set of one or more primitives.

17. The graphics processor of claim 13, wherein a sub-set of one or more primitives in the set of primitives comprises a group of plural primitives in the set of primitives; and
the set of lower level data for the sub-set comprising a group of plural primitives in the set of primitives encodes data for one or more primitives in the group of plural primitives relative to data for at least one other primitive in the group of plural primitives.

18. A graphics processor operable to perform tile-based rendering, in which a render output is divided into a plurality of tiles for rendering purposes, the graphics processor operable to process packets comprising respective sets of primitives to be processed for a render output, the graphics processor comprising:
a processing circuit configured to process primitives for a render output; and
a packet reading circuit configured to:
use bounding boxes associated with packets comprising respective sets of primitives to be processed for a render output to identify whether any of the packets should be read for a respective region of a render output being generated; and
when it is identified that a packet should be read for a region of a render output:
read from the packet a set of higher level data for processing a set of primitives in the packet;
use bounding boxes associated with sub-sets of one or more primitives in the set of primitives to identify whether any of the sub-sets of one or more primitives should be processed for the region of the render output; and
for a sub-set of one or more primitives that it is identified should be processed for the region of the render output:
read from the packet a set of lower level data for processing the primitive or primitives in the sub-set of one or more primitives; and
provide, to the processing circuit, a primitive or primitives in the sub-set of one or more primitives to be processed, together with data to be used to process the primitive or primitives based on the set of higher level data and the set of lower level data.

19. The graphics processor of claim 18, wherein the packet reading circuit is configured to:
for a sub-set of primitives comprising a group of plural primitives that it is identified should be processed for a region of a render output:
read from the packet a set of lower level data for processing primitives in the group of plural primitives;
identify whether any of the primitives in the group of plural primitives should be processed for the region of the render output; and
when it is identified that one or more primitives in the group of plural primitives should be processed for the region of the render output:
provide, to the processing circuit, the one or more primitives in the group of plural primitives that it is identified should be processed for the region of the render output, together with data to be used to process the primitive or primitives based on the set of higher level data and the set of lower level data.

20. The graphics processor of claim 18, wherein the packet reading circuit is configured to read a set of lower level data from a packet by decoding a set of commands for the set of lower level data; and
decoding the set of commands for the set of lower level data comprises decoding a command in the set of commands that is encoded relative to one or more other commands in the set of commands.
